(19) United States
(12) Patent Application Publication
(10) Pub. No.: US 2017/0330130 A1
(43) Pub. Date: Nov. 16, 2017

(54) Bespoke Service-On-Demand Platform Enabling Translation Of Staff-To-Staff Requests

(71) Applicant: FIVEPALS. Inc., New York, NY (US)

(72) Inventors: Dmitry Koltunov, New York, NY (US); Alexander Shashou, New York, NY (US); Justin Effron, New York, NY (US); Samuel Evers, New York, NY (US)

(73) Assignee: FIVEPALS, Inc., New York, NY (US)

(21) Appl. No.: 15/668,083

(22) Filed: Aug. 3, 2017

Related U.S. Application Data
(63) Continuation of application No. 14/726,025, filed on May 29, 2015.

(51) Int. Cl. G06Q 10/06; G06Q 50/12

(52) U.S. Cl. CPC G06Q 10/063112; G06Q 50/12

(57) ABSTRACT

A computational system, which is a bespoke service-on-demand platform, is described. One or more computing units can receive a request generated by a staff computing device associated with staff of a property over a first communication network via a staff application programming interface (API), the request being formulated in a first language. The computing unit(s) can receive the request from the staff application programming interface and cause the request to be translated from the first language into a second, different language to form a translated request. The staff API can receive the translated request in the second, different language, and send the translated request to another staff computing device associated with staff of the property and operably coupled to the staff API via a second communication network.

### TECHNICAL FIELD

The subject matter described herein relates to a computational system that can receive a request that is generated either by a guest application that can be operated by a guest at a property (for example, a hotel) or a staff application that can be operated by a staff member at the property, route the request to a relevant staff member within a relevant department amongst multiple departments of the property that should handle (for example, work on) the request, enable real-time service oriented communication (for example, between the guest and the relevant staff member, when the request has been generated on the guest application or on the staff application on behalf of the guest), and display analytics indicating service quality across departments to an authorized staff member (for example, a property administrator or manager) of the property.

### BACKGROUND

The hospitality industry includes many types of properties, such as hotels, resorts, spas, inns, apartment buildings, condominiums, and the like. Each property is typically serviced by a staff split into many departments, such as laundry, kitchen, front desk, concierge, and so on. These different departments need to communicate with property guests as well as communicate internally within those departments in order to coordinate and ensure a smooth functioning of the property. When a guest of a property desires to place a request (for example, a request for a service, such as a request for a laundry service), the guest traditionally calls a front desk staff member and places the request. The front desk staff member then telephones, via an internal system such as an intercom, the relevant department (for example, the laundry department) to convey the request, and requests a staff member of the relevant department to address the request by the guest. However, such communication is inefficient and undesirable, as per at least the points that follow.

The internal communication between the property departments is opaque to the guest. Additionally, involvement of human individuals (for example, front desk personnel) in conveying the requests internally between the departments can induce manual error while conveying requests by guests to the relevant department. Further, use of disparate communication systems (for example, telephone and internal intercom system) for conveying requests by guests and responses to those requests is time consuming and technically inefficient. Moreover, such conventional communication systems do not collect data characterizing requests for multiple departments and responses to those requests. Absence of this collected data results in lack of accountability, and prevents generation of analytics showing service quality across departments, thereby not allowing any means for property administrators to effectively determine how the departments are performing while servicing the guests of the property.

### SUMMARY

A computational system is described that can receive a request that is generated either by a guest application that can be operated by a guest at a property (for example, a hotel) or a staff application that can be operated by a staff member at the property, route the request to a relevant staff member within a relevant department amongst multiple departments of the property that should handle (for example, work on) the request, enable real-time service oriented communication (for example, between the guest and the relevant staff member, when the request has been generated on the guest application or on the staff application on behalf of the guest), and display analytics indicating service quality across departments to an authorized staff member (for example, a property administrator or manager) of the property.

In one aspect, a computational system includes a guest application programming interface, one or more computing units, and a staff application programming interface. The guest application programming interface can receive a request generated on a guest application operably coupled to the guest application programming interface via a first communication network. The one or more computing units can receive the request from the guest application programming interface. The one or more computing units can read the request to determine a relevant department within a plurality of departments of a property that should handle the request. The staff application programming interface can receive data indicating the receipt of the request by the one or more computing units. The staff application programming interface can generate a notification indicating the receipt of the request. The staff application programming interface can send the notification indicating the receipt of the request to a staff application operably coupled to the staff application programming interface via a second communication network.

In some variations, one or more of the following can also be implemented either individually or in any feasible combination. The guest application programming interface can receive an indication of an activity associated with the request from the staff application when the staff application receives an input indicating the activity associated with the request. The guest application programming interface can send a notification indicating the activity associated with the request to the guest application. The guest application can display the notification indicating the activity associated with the request.

The activity associated with the request can include at least one of: an acceptance of the request, an initiation of addressing the request, a pausing of addressing the request, a completion of the request, a deletion of the request, editing contents of the request, adding internal notes to the request, chatting with a guest, and applying other workflow transitions that vary for different requests.

The computational system can further include a message queue that can receive data representing the request from the guest application programming interface. The one or more computing units can receive the request from the guest application programming interface via the message queue. The one or more computing units can include an authorization computing unit, a validation computing unit, a persistence computing unit, a processing computing unit, and a dispatch computing unit. The authorization computing unit can receive the data representing the request from the message queue. The authorization computing unit can use a property management system to verify that an individual who has placed the request is a current occupant of the property. The validation computing unit can verify that the request is feasibly serviceable. The persistence computing unit can persist the request in a database system after the individual who has placed the request is verified to be a current occupant of the property and after the verification that the request is feasibly serviceable. The processing computing unit can invoke and apply at least one business rule on the request to process the data representing the request. The dispatch computing unit can generate the processed data representing the processed request. The dispatch computing unit can send the data representing the processed request in another message queue through which the data representing the processed request can be sent to the staff application programming interface.

The dispatch computing unit can dispatch a notification that the request has been received to one or more entities via at least one of email, phone, point of sales system and a third party application programming interface. The processed data representing the request can be stored in a scalable cloud computing cache that can be adjusted for any number of requests.

The message queue can receive data representing an activity associated with the request from the staff application programming interface, the one or more computing units receiving the data representing the activity associated with the request from the guest application programming interface via the message queue. The activity associated with the request can include at least one of: an acceptance of the request, an initiation of addressing the request, a pausing of addressing the request, a completion of the request, a deletion of the request, editing contents of the request, adding internal notes to the request, chatting with a guest, and applying other workflow transitions that vary for different requests.

The authorization computing unit can authorize the data representing the activity associated with the request from the message queue. The validation computing unit can validate that the activity associated with the request is feasible. The persistence computing unit can persist the data representing the activity associated with the request in a database system after the authorizing and the validating of the activity. The processing computing unit can invoke and apply at least one business rule on the data representing the activity associated with the request to process the data process the representing the activity associated with the request. The dispatch computing unit can generate data representing the processed data representing the activity associated with the request. The dispatch computing unit can send the data representing the activity associated with the processed request in another message queue through which the data representing activity associated with the processed request is sent to the guest application programming interface. The dispatch computing unit is further configured to dispatch a notification that the activity associated with the request has been performed to one or more entities via at least one of email, phone, point of sales system and a third party application programming interface.

The computational system can further include a database that can store the request along with data associated with a response to the request. The computational system can further include an analytics application programming interface to access the database to generate at least one of insights and trends associated with historical requests and historical responses to the historical requests. The historical requests can include the request. The historical responses can include the response to the request. The analytics programming interface can send the analytics to the staff application when an individual logged into the staff application is authorized to access the analytics. The staff application can display the analytics.

The analytics application programming interface can generate one or more reports including the analytics. The analytics application programming interface can send the one or more reports to the staff application or to one or more entities via at least one of the first communication network and the second communication network.

The staff application can provide different levels of access to different entities accessing the staff application. The staff application can identify a level of access associated with each entity based on authentication data provided by the entity. The staff application can display analytics and data used to generate the analytics when an entity having a particular access level is logged in to the staff application. The first communication network can be one of internet and intranet. The second communication network can be one of the internet and the intranet.

In another aspect, one or more computing units of a computational system can receive a request for performing a service associated with a property. The one or more computing units can read the request to determine a relevant department within a plurality of departments of the property that should handle the request. The one or more computing units can send an indication of receipt of the request by the one or more computing units and the relevant department to a staff application programing interface of the computational system. The staff application programming interface can generate a notification indicating the receipt of the request. The staff application programming interface can send the notification to a staff application executed by the relevant department via a first communication network.

In some variations, one or more of the following can also be implemented either individually or in any feasible combination. The one or more computing units can send an indication of an activity associated with the request to a guest application programing interface of the computational system. The activity is supposed to be performed by an entity of the relevant department. The guest application programming interface can generate a notification indicating the activity associated with the request. The staff application programming interface can generate the notification indicating the activity associated with the request to a guest application via a second communication network. The activity associated with the request can include at least one of: an acceptance of the request, an initiation of addressing the request, a pausing of addressing the request, a completion of the request, a deletion of the request, editing contents of the request, adding internal notes to the request, chatting with a guest, and applying other workflow transitions that vary for different requests.

The one or more computing units can receive the request from the staff application programming interface. The staff application programming interface can receive the request from the staff application. The one or more computing units can send an indication of receipt of the request by the one or more computing units to a guest application programing interface of the computational system. The guest application programming interface can generate a notification indicating the receipt of the request.

The guest application programming interface can send the notification to a guest application via a second communication network.

The one or more computing units can receive the request from a guest application programming interface. The guest application programming interface can receive the request from a guest application via a second communication network. The first communication network can be one of internet and intranet. The second communication network can be one of the internet and the intranet.

The one or more computation units can receive the request from an automatic request generator that generates the request based on one or more business rules. The one or more business rules can include logic based on dates, schedules, location, or analytical insights. The one or more computing units can receive contextual information on the staff members of the relevant department including schedules, dates, locations, load and capacity, or analytical insights. The one or more computing units can determine available staff members based on the contextual information. The sending of the notification can include sending the notification to the staff application logged in by the available staff members. The request can demand at least one of a service for the guest and a service for a physical portion of the property.

In a yet another aspect, a non-transitory computer program product is described that can store instructions that, when executed by at least one programmable processor, cause the at least one programmable processor to perform operations including: receiving a request for performing a service associated with a property; reading the request to determine an available staff member within a relevant department amongst a plurality of departments of the property that should handle the request; generating a notification indicating the receipt of the request; and sending the notification indicating the receipt of the request to a staff application operated by the available staff member via a first communication network.

In some variations, one or more of the following can also be implemented either individually or in any feasible combination. The request can be received from at least one of: a guest application when a guest of the property generates the request by using the guest application, and the staff application when a staff member of the property generates the request on behalf of the guest by using the staff application. The operations can further include: receiving, from the staff application, an indication of an activity associated with the request, the activity supposed to be performed by the available staff member; generating a notification indicating the activity associated with the request; and sending the notification indicating the activity associated with the request to the guest application via a second communication network. The request can be an internal request generated by the staff application. The request can be received from the staff application, can be automatically generated by the staff application based on one or more of: logic based on one or more of dates, schedules, location, and analytical insights.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a computational system that can receive a request that is generated either by a guest application that can be operated by a guest at a property (for example, a hotel) or a staff application that can be operated by a staff member at the property, route the request to a relevant staff member within a relevant department amongst multiple departments of the property that should service the request, enable real-time service oriented communication (for example, between the guest and the relevant staff member, when the request has been generated by or on behalf of the guest), and display analytics indicating service quality across departments to an authorized staff member (for example, a property administrator or manager) of the property;

FIG. 2 is another system diagram illustrating the computational system;

FIG. 3A is a flow diagram illustrating the process of communication, as enabled by the computational system, between a computing device of the guest and a computing device of the relevant department when the request is generated by a guest;

FIG. 3B is a flow diagram illustrating the process of communication, as enabled by the computational system, between a computing device of the guest and a computing device of the relevant department when the guest-related request is generated by a staff member on behalf of a guest;

FIG. 3C is a flow diagram illustrating the process of communication, as enabled by the computational system, when an internal request is generated by a staff member;

FIG. 4 illustrates a data-model that shows an interlinkage between objects used within the programming code executed by the computational system;

FIG. 5 illustrates a workflow model that shows various states (also referred to as statuses) indicating actions performed by a staff member while addressing a request;

FIG. 6 illustrates a tabular mapping between a custom status customized for property management, status interpreted by the computational system, and a type of the status;

FIG. 7 illustrates screens executed by guest application to enable a guest to request a service;

FIG. 8 illustrates screens executed by the guest application to display a request placed on a computing device of a guest of a property, and to enable communication regarding the request between the computing device of the guest and a computing device of the staff member of the property;

FIG. 9 illustrates a graphical user interface, of a computing device (that is, smartphone, in this example) that executes a staff application, displaying a notification indicating that the staff application has received a request from a computing device of a guest;

FIG. 10 illustrates a notification, indicating receipt of a new request from a computing device of a guest, within a staff application when a staff member is using the staff application;

FIG. 11 illustrates a screen executed by the staff application to display a ticket generated for a request placed on a computing device of a guest;

FIG. 12 illustrates screens executed by the staff application to display a request placed on a computing device of a guest, details associated with the request, and communication regarding the request between a computing device of a staff member and a computing device of the guest;

FIG. 13 illustrates screens executed by the staff application to enable the staff member to place an internal request;

FIG. 14 illustrates a web-page executed by the guest application, when accessed on a computing device of a guest via a web browser, to enable the guest to generate a request;

FIG. 15 illustrates a web-page executed by the guest application, when accessed on a computing device of a guest via a web browser, to display the current orders (that is, current requests) and past orders (that is, past requests) placed by the guest;

FIG. 16 illustrates a web-page executed by the staff application, when accessed by a staff member via a web browser, to display guest requests, internal requests, and a ticket and current custom handling status for each request;

FIG. 17 illustrates another example of a web-page executed by the staff application, when accessed by a staff member via a web browser, to display guest requests, internal requests, and a calendaring tool;

FIG. 18 illustrates a pop-up screen popping out of a web-page executed by the staff application, when accessed by a staff member via a web browser, to receive requests related to at least one of guest rooms and guests from the staff member;

FIG. 19 illustrates a web-page executed by the staff application, when accessed by a concierge staff member via a web browser, to enable the concierge staff member to make recommendations while using the staff application; and

FIG. 20 illustrates a web-page executed by a staff application, when accessed by an authorized staff member (for example, a property administrator or manager) via a web browser, to display analytics to the an authorized staff member.

Like reference symbols in the various drawings indicate like elements.

### DETAILED DESCRIPTION

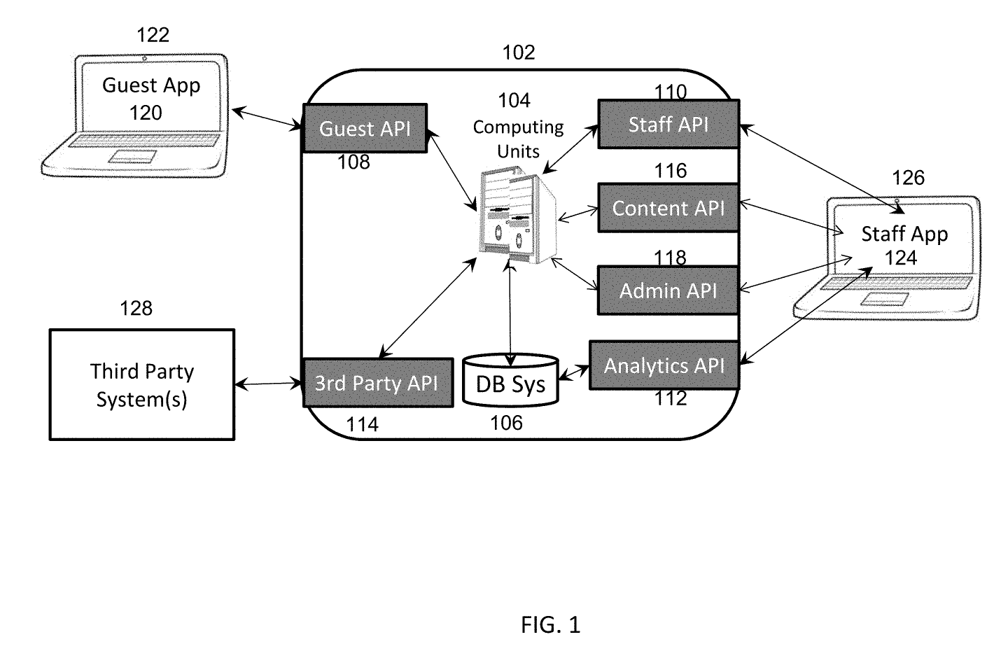

FIG. 1 is a system diagram illustrating a computational system 102 that can receive a request that is generated either by a guest application that can be operated by a guest at a property (for example, a hotel) or a staff application that can be operated by a staff member at the property, route the request to a relevant staff member within a relevant department amongst multiple departments of the property that should service the request, enable real-time service oriented communication (for example, between the guest and the relevant staff member, when the request has been generated by or on behalf of the guest), and display analytics indicating service quality across departments to an authorized staff member (for example, a property administrator or manager) of the property. The computational system 102 can include computing units 104, a database system 106, a guest application programming interface (API) 108, a staff API 110, an analytics API 112, a third party API 114, a content API 116 and an admin API 118.

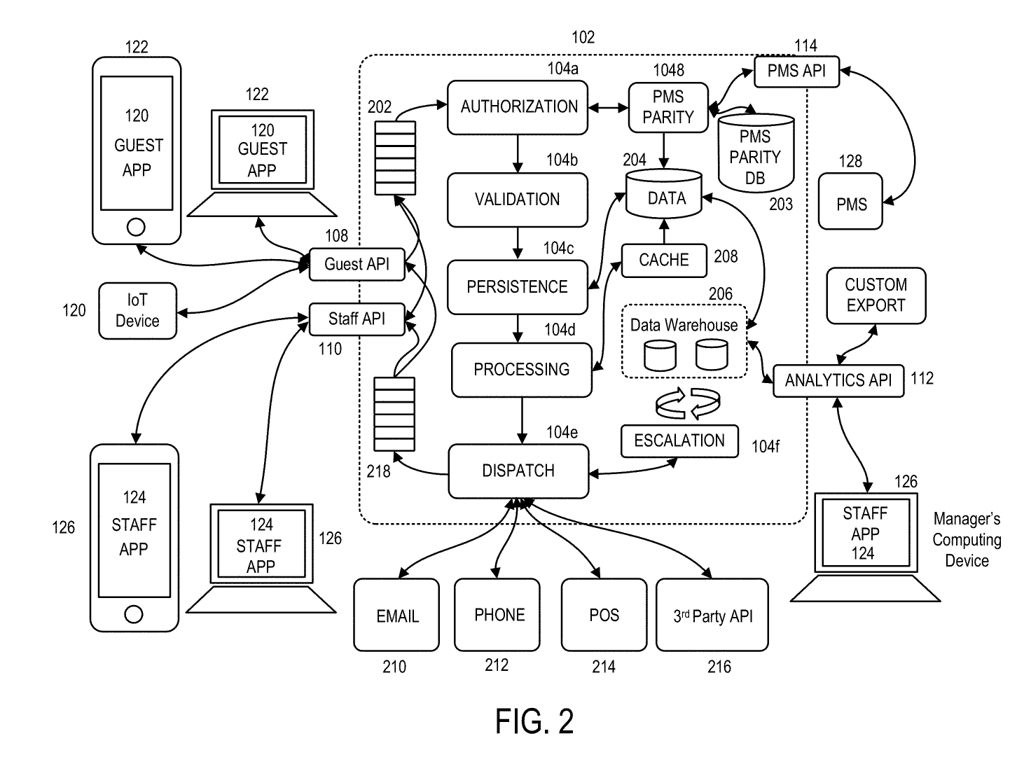

The computing units 104 can have a service-oriented architecture. The computing units 104 can include different sets of one or more processors used to service one or more functions, such as authorization, validation, persistence, processing, dispatch, and escalation, as described in more detail by FIG. 2, which is discussed below. A computing unit can be any suitable hardware, software, firmware, or any combination thereof that is capable of performing the functions described herein. In some embodiments, multiple computing units (for example, multiple, discrete hardware devices and/or software modules) may be employed. In an alternative implementation, a single computing unit may be utilized to perform all the functions. The database system 106 can be a set of one or more storage structures, as described in more detail below by FIG. 2.

The guest API 108 can enable communication between a guest application 120 executed on a computing device 122 configured to be used by the guest and the computational system 102. The staff API 110 can enable communication between a staff application 124 executed on a computing device 126 configured to be used by a staff member and the computational system 102. The analytics API 112 can enable display of analytics within the staff application 124 to authorized staff members (for example, property management) only. The third party API 114 can enable communication between the computational system 102 and one or more third party systems 128, such as a property management system (PMS), a building management system, and any other third party system. The content API 116 can enable translation of content between the computational system 102 and the staff application 124 and vice versa. The admin API 118 can control the settings of the computational system 102, create properties specific to the computational system 102, manage users (for example, staff members and/or guests), and manage permissions that affect the function of the computational system 102. This admin API 118 can be used to enable and/or disable some property-specific functionalities for each property.

The computing units 104 can send data to and read data from the guest API 108 in the JavaScript Object Notation (JSON) format. The computing units 104 can send data to and read data from the staff API 110 is in the JSON format. The receiving and sending of the data, as described in this paragraph, can occur over HyperText Transfer Protocol (HTTP) or HyperText Transfer Protocol Secure (HTTPS). The guest API 108 and the staff API 110 can be implemented using the Representational State Transfer (REST) protocol. Although JSON format, HTTP, HTTPS, and REST protocol are described, in alternate implementations, any other feasible variation of any one of these elements can be used.

The computing device 122 can be any one of a laptop computer, a desktop computer, a tablet computer, a smart phone, a phablet computer, a computing kiosk, an internet of things (IoT) device, and/or any other computing device. The computing device 126 can be any one of a laptop computer, a desktop computer, a tablet computer, a smart phone, a phablet computer, a computing kiosk, and/or any other computing device. The storage structures of the database system 106 can store data in a tabular format. In other implementations, the data can also be stored as NoSQL, or any other suitable data format. Those storage structures can be hierarchical databases. Those storage structures can be either a columnar database or a row based database. In one implementation, the storage structures can be an in-memory database. The computational system 102 can be operably connected to the computing device 122 via a communication network, which can be one or more of a local area network, a wide area network, internet, intranet, Bluetooth network, infrared network, and other communication networks. The computational system 102 can be operably connected to the computing device 126 via a communication network, which can be one or more of a local area network, a wide area network, internet, intranet, Bluetooth network, infrared network, and other communication networks.

As noted above, a third party system 128 can be a property management system (PMS). The third party API 114 that connects the computational system 102 with the PMS 128 can be a middleware API. In alternate implementations, the computational system 102 can be operably directly connected to the PMS 128.

The property described herein can be hotels, resorts, spas, inns, apartment buildings, condominiums, another real estate property, and/or any hospitality organization. The request described herein can also be referred to as a request ticket, a service request, a service ticket, a request object, a request unit, and/or an ALICE request.

FIG. 2 is another system diagram illustrating the computational system 102. The guest API 108 can receive a request (for example, request for room cleaning) from a computing device 122 configured to be operated by a guest. The guest API 108 can then push a message including the request to a message queue 202. The message including the request is then handled by the computing units 104, which include an authorization computing unit 104a, a validation computing unit 104b, a persistence computing unit 104c, a processing computing unit 104d, a dispatch computing unit 104e, an escalation computing unit 104f, and a property management system (PMS) parity computing unit 104g.

The authorization computing unit 104a pulls the message including the request from the message queue 202, verifies the status of the guest with the corresponding property management system (PMS) 128 by using the guest qualifying information (for example, guest's last name and guest's room number), and authorizes the message as being from a verified occupant of the property. The authorization computing unit 104a can verify with the PMS 128 by communicating with the computing PMS parity computing unit 104g, which can communicate with the PMS 128 via the third party API 114. The PMS parity computing unit 104g can be operably connected to the PMS parity database 203.

Although guest's last name and guest's room number are presented above as examples of the guest qualifying information, in other implementations, other examples may also be possible. Every property can decide what the guest qualifying information should be for that property. Some other examples of guest qualifying information can be an access code allocated to the guest, email address of the guest, a first name of the guest, dates of check-in and/or check-out by the guest, and so on. For non-hotel properties like condos, the guest qualifying information can be a tenant identifier, or the like. The computational system 102 can incorporate such variations in the guest qualifying information. The computational system 102 can be configured to use different qualifying information pre-arrival, during stay, and/or after stay by the guest, if preferred so by the corresponding property.

The integration of the computational system 102 with the property management system (PMS) 128 can be bidirectional, as the PMS parity computing unit 104g can read data from as well as write data to the PMS 128. For example, the PMS parity computing unit 104g can read the following data from the PMS 128: reservation data parity, guest basic profile, guest full profile (for example, loyalty, history, etc.), guest folio (for example, room bill), list of rooms, room types, and locations (or any other list of values (LOV) related to the property), guest room status (for example, open or occupied), housekeeping room status (for example, dirty or clean). The PMS parity computing unit 104g can write the following data to the PMS 128: guest folio (for example, room bill, and entire lifecycle of add, cancel etc.), guest check-out, guest check-in, guest room assignment or change, guest payment registration, change housekeeping room status, and change guest room status. The data that is read from the PMS 128 can be stored in the PMS parity database 203. If there are any changes to the reservation of a unit of the property, the computational system 102 can save those changes in the database 204.

The validation computing unit 104b can then validate whether the content of the request is proper and at an appropriate time. The validation can be performed based on property-specific business rules preferred and/or desired by each property. The validation can be performed either automatically or manually by an administrator or manager of the property. For example, validation for time related requests (for example, a request requesting food at a time when the kitchen is closed) can be performed automatically. Validation for some other requests (for example, a request requesting a monkey in the room) may need to be performed manually.

The persistence computing unit 104c can then persist (for example, store) the validated request into the database 204. The data associated with the validated request in the database 204. The database 204 can be operably connected to the data warehouse (also referred to as an enterprise data warehouse) 206.

The processing computing unit 104d can then invoke and apply one or more business rules on the request to process the data representing the request process the validated request. The processing of the validated request can update the cache memory 208 that is operably connected to the database 204. The cache memory 208 can be a cloud cache layer, which is implemented in addition to the database 204 for providing a quick access to the data stored in the cache memory 208. The cache memory 208 can store data that needs to be quickly accessed, such as property data, reservations on the property, and tickets generated based on requests. All the data stored in the cache memory 208 may have the JSON format, or any other suitable format.

The dispatch computing unit 104e can then dispatch a notification to various entities that a new valid request has been received. The notification can be sent to some specific staff members via at least one of email 210, phone 212, point of sale (POS) system 214, a third party API 216, and a web hook, which can convey the notification to a third party. The dispatch computing unit 104e can send the message with the valid request to another message queue 218.

The staff API 110 can communicate the message with the valid request from the message queue 218 to the staff application 124 executed by the computing device 126 configured to be operated by a staff member in the property. The staff application 124 can then display that a request has been received.

The staff application 124 can allow a staff member (who can log in to the staff application 124 to access data for one or more properties, as authorized) to create a ticket for the request when the request is displayed in the staff application 124. The staff application 124 can also allow the staff member to perform other activities associated with the request, such at least one of: an acceptance of the request, an initiation of addressing the request, a pausing of addressing the request, a completion of the request, a deletion of the request, editing the contents of the request, adding internal notes to the request, chatting with the guest, and/or applying any other workflow transitions, which may vary based on the request. When the ticket is created or an indication of any activity associated with the request is received by the staff application 124, the staff API 110 can send a message, specifying the activity associated with the request, to the message queue 202. The authorization computing unit 104a can authorize data representing the activity associated with the request from the message queue 202. The validation computing unit 104b can validate that the activity associated with the request is feasible. The persistence computing unit 104c can persist the data representing the activity associated with the request in the database 2014 after the authorizing and the validating of the activity. The processing computing unit 104d can invoke and apply at least one business rule on the data representing the activity associated with the request to process the data representing the activity associated with the request. The processed data representing the activity can be stored in a cache 208, which can be a scalable cloud computing cache that is adjustable for any number of requests. The dispatch computing unit 104e can generate data representing the processed data representing the activity associated with the request, and can send this data to various entities (for example, staff members) via email 210, phone 212, POS 214, a third party API 216, and a web widgets. The dispatch computing unit 104e can also send this data representing the activity associated with the processed request in another message queue 218, via which this data representing activity associated with the processed request is sent to the guest API 108.

The guest API 108 can then send the message specifying that the activity associated with the request (for example, a receipt of the request, an acceptance of the request, an acceptance of the request, an initiation of addressing the request, a pausing of addressing the request, a completion of the request, a deletion of the request, editing the contents of the request, adding internal notes to the request, chatting with the guest, and/or applying any other workflow transitions, which may vary based on the request) to the guest application 120, which can then display the message specifying that activity associated with the request.

As described above, the guest application 120 can allow a guest to request a service. However, in some situations, the staff members may also need to place requests for services, such as room cleaning and reporting a broken sink for a unit (for example, a room or a condominium) in the property. To address such situations, the staff application 124 can allow a staff member to generate a request (for example, an internal request or a request on behalf of a guest), and perform other activities associated with the request, such as an acceptance of the request, an initiation of addressing the request, a pausing of addressing the request, a completion of the request, a deletion of the request, editing the contents of the request, adding internal notes to the request, chatting with the guest, and/or applying any other workflow transitions, which may vary based on the request. When this request is generated (which can be understood to be one of the activities associated with the request) in the staff application 124 or an indication of any other activity (as noted above) related to the request is received by the staff application 124, the staff API 110 can send this request to message queue 202. The authorization computing unit 104a can authorize data representing the activity associated with the request from the message queue 202. The validation computing unit 104b can validate that the activity associated with the request is feasible. The persistence computing unit 104c can persist the data representing the activity associated with the request in the database 204 after the authorizing and the validating of the activity. The processing computing unit 104d can invoke and apply at least one business rule on the data representing the activity associated with the request to process the data representing the activity associated with the request. The processed data representing the activity can be stored in the cache 208, The dispatch computing unit 104e can generate data representing the processed data representing the activity associated with the request, and can send this data to various entities (for example, staff members) via email 210, phone 212, POS 214, a third party API 216, and a web widgets. The dispatch computing unit 104e can also send this data representing the activity associated with the processed request in another message queue 218, via which this data representing activity associated with the processed request is sent to the staff API 108. Note here that a guest does not need to be informed of an activity associated with the internal request, as the guest is not aware of such an internal request. However, if a specific property desires notifying guests of activities associated with some internal requests or in case of the request being generated on behalf of the guest, the computational system 102 can enable generation and sending of this notification in a manner described above with respect to notifying activities associated with guest-generated requests.

Similar to guest-generated requests and staff-member generated requests noted above, some requests can be generated automatically by the staff API 110. The staff API 110 can automatically generate these requests based on business rules, such as logic based on dates, schedules, location, or analytical insights. A staff member can use the staff application 124 to perform various activities on this automatically generated request. The staff API 110 can send the automatically generated request to the message queue 202. The authorization computing unit 104a can receive data representing the activity associated with the request from the message queue 202, and authorize this data. The validation computing unit 104b can validate that the activity associated with the request is feasible. The persistence computing unit 104c can persist the data representing the activity associated with the request in the database 204 after the authorizing and the validating of the activity. The processing computing unit 104d can invoke and apply at least one business rule on the data representing the activity associated with the request to process the data representing the activity associated with the request. The processed data representing the activity can be stored in the cache 208. The dispatch computing unit 104e can generate data representing the processed data representing the activity associated with the request, and can send this data to various entities (for example, staff members) via email 210, phone 212, POS 214, a third party API 216, and a web widgets. The dispatch computing unit 104e can also send this data representing the activity associated with the processed request in another message queue 218, via which this data representing activity associated with the processed request is sent to the staff API 108.

The escalation computing unit 104f can constantly (for example, every predetermined amount of time, such as one minute) check the data warehouse 206, which stores the data associated with the requests (including guest-generated requests, requests generated by a staff member, and automatically generated requests), to determine whether any request has not been addressed or completed within due time or date. If a request has not been addressed/fulfilled within due time or date, the escalation computing unit 104f can escalate the addressing of the request by first sending the request to the staff members via email 210. If the request is not addressed within a subsequent predetermined amount of time (for example, two minutes after the due time or date), the escalation computing unit 104f can send the request to a senior staff member or supervisor via a phone call 212. The computational system 102 can allow different properties to have different property-specific reasons for performing this escalation. The computational system 102 can also allow alteration of the escalation work-flow based on specifications and/or preferences of the property.

The dispatch computing unit 104e can dispatch emails 210 and phones 212 by using a third party email provider API and telephone provider API, respectively. The dispatch computing unit 104e can dispatch to a point of sale (POS) system 214 by using a middleware API, which allows integrating one or more POS systems with an API or a web hook.

The computational system 102 can use the analytics API 112 to present analytics, including insights and trends related to historical requests and addressing of those requests, on the staff application 124 to authorized staff members, such as property managers, property administrators, and/or the like. The computational system 102 can use data stored in the data warehouse 206 to generate the analytics. The computational system 102 can update the data warehouse 206 by extracting data from the database 204 (which stores: data characterizing all past requests and an action performed by a staff member to service each request, and data based on all inputs received by either the guest application 120 or the staff application 124), transforming that data into a format suitable for storage, and loading the transformed data into the data warehouse 206. The computational system 102 can display the analytics on an analytics dashboard shown by the staff application 124. The computational system 102 can customize the analytics for a specific property and for specific types of requests.

The analytics API 112 can generate one or more reports including the analytics. The analytics API 112 can send the one or more reports to the staff application or to one or more entities via a communication network, such as one of Internet and intranet (for example, local area network). One example of a report can be a document sent via an email, wherein the document can be a portable document format (PDF) document, a Microsoft Word document, a Microsoft Excel document, an image, and/or any other document. The analytics API 112 can generate insights using the analytics, and can send data representing these analytics to the staff API 110, which can then apply business rules on the insights to automatically generate a request, which can then be displayed by the staff application 124.

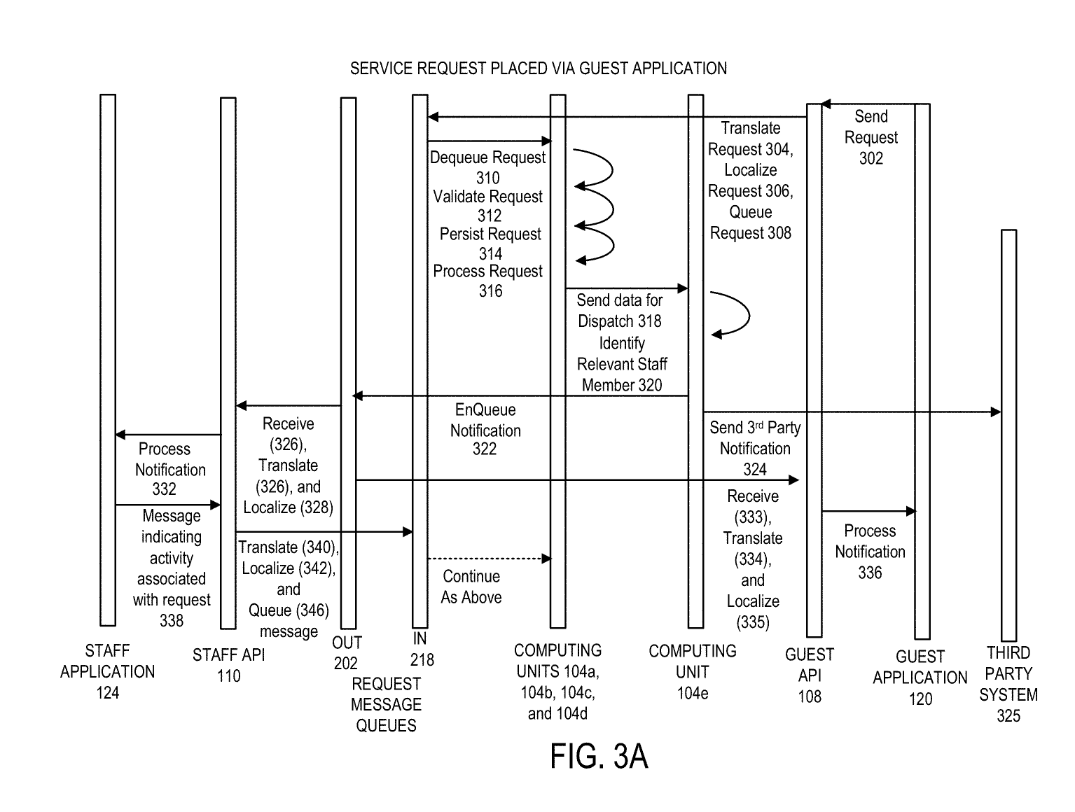

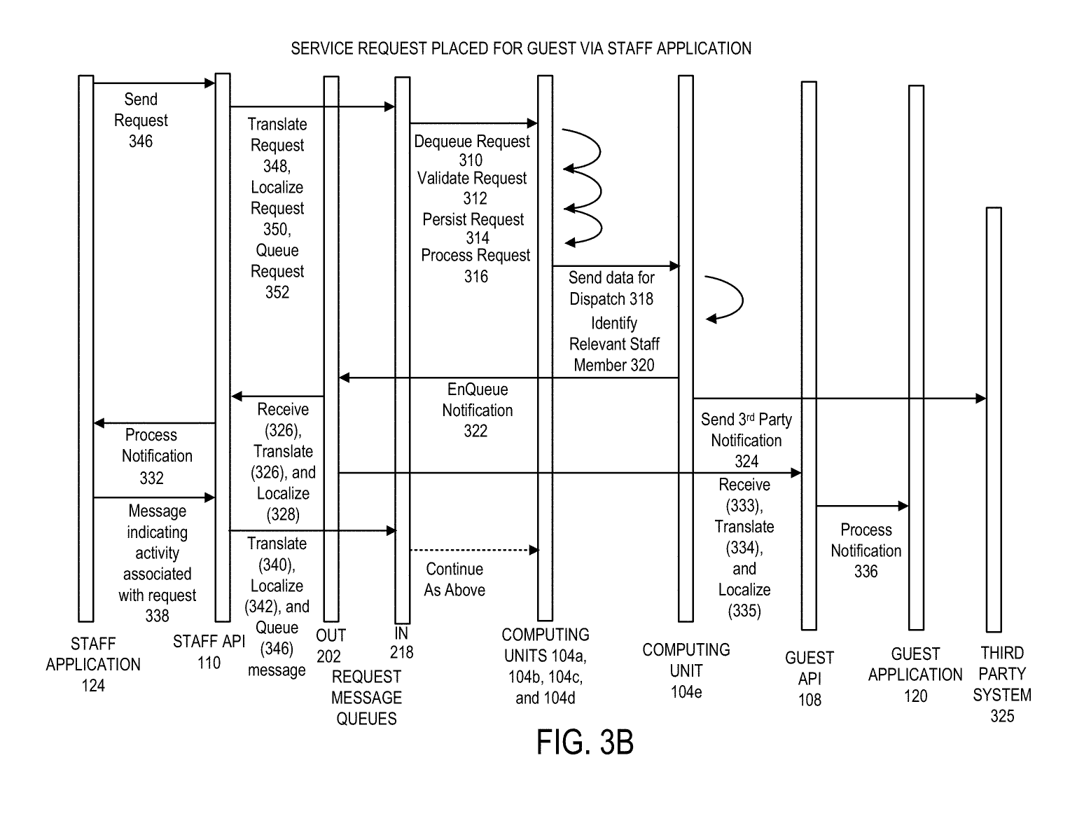

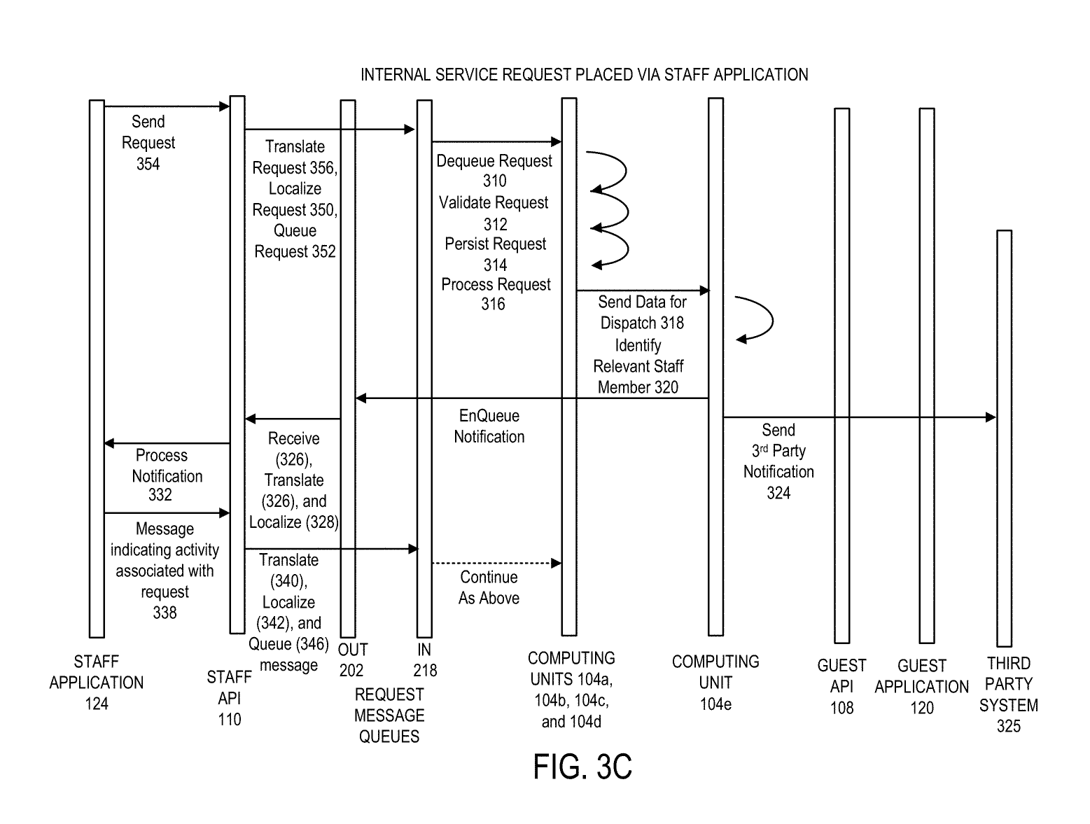

FIG. 3A is a flow diagram illustrating the process of communication, as enabled by the computational system 102, between a computing device 122 of the guest and a computing device 126 of the relevant department when the guest-related request is generated on the guest application 120. The guest application 120 on the computing device 122 can send, at 302, a request requesting a service to the guest API 108. The guest API 108 can translate the request at 304. The translation can translate, in real-time, any language, currency, and date-time (which includes timezone, such as Eastern

Standard Time or Eastern Time, and display specifications) to a language, currency, and date-time preferred by the guest of the property, respectively. The guest API 108 can localize the request at 306 in order to locally display the translated language, currency, and time. The guest API 108 can queue, at 308, the request in the message queue 202.

The computational system 102 can manage the translation described herein by using a local translation memory, which stores data generated from historically manual translations and machine translations. If a translation for the desired text is not available, the computational system 102 can look it up using a real time translation API. On some frequency, administrators of the computational system 102 can review machine translations and correct the local translation memory where necessary. Translation can occur over the following three general sets of information: system messages, content from the content management system (CMS) where the property is managed, and real time interactions between guest and staff. The computational system 102 allows a user to place a request in one language and receive data specifying activities (by a staff member addressing the request) associated with the request in another language.

The authorization computing unit 104a can dequeue, at 310, the request, and can then authorize the request. The validation computing unit 104b can validate the authorized request at 312. The persistence computing unit 104c can then persist, at 314, data associated with the validated request in the database 204. The processing computing unit 104d can invoke and apply at least one business rule on the data representing the request to process, at 316, the data representing the request. The processing computing unit 104d can send, at 318, data for dispatch to the dispatch computing unit 104e. The data for the dispatch refers to data used to generate a notification that a new valid request has been received.

The dispatch computing unit 104e can then use the received data to generate a notification that a new valid request has been received that a new valid request has been received. The dispatch computing unit 104e can identify, at 320, a relevant staff member that should be notified with the notification. To identify the relevant staff member, the dispatch computing unit 104e can apply one or more business rules with various heuristics, as follows. The relevant staff member can be one or more staff members working in the department related to the request. The relevant staff member can be an individual who is supposedly working when the request is received and is likely to remain active. The relevant staff member can be an individual who is supposedly working (as represented by a shift, which can be listed in a shift schedule of the staff members) when the request is received and has a high availability (for example, has an availability of more than a threshold amount of time) or most availability. The business rules (such as those listed above) that are applied for a property can be specified by the property. This intelligent identification of the relevant staff member by the computational system 102 can be disabled for any property, and manual identification can be performed, if the property prefers so.

In the unlikely event that the request is sent to an inappropriate staff member, the staff application 124 still allows this staff member to reassign the request to one or more relevant staff members. In some implementations, a request can be reassigned for other reasons too, such as logistical requirements of the property.

The dispatch computing unit 104e can send, at 322, the generated notification that a new valid request has been received to the message queue 218. The dispatch computing unit 104e can generate a third party notification based on this notification, and can send, at 324, the third party notification to third party systems 325 via at least one of email 210, phone 212, point of sale (POS) system 214, a third party API 216, and a web hook.

The staff API 110 can then receive the notification from the message queue 218 at 326, and can then translated the notification at 328 and localize the notification at 330. The staff API 110 can invoke and apply at least one business rule on the notification to process the notification at 332. The staff API 110 can send the processed notification to the staff application 124. The staff application 124 can display or output, in any other way, the notification to indicate to the relevant staff member that a processed (that is, proper) request has been received.

Once the staff application receives the processed notification at 332, the guest API 110 can receive a notification indicating delivery of request to the staff application 124 from the message queue 218 at 333. The guest API 110 can translate the notification indicating delivery of request to the staff application 124 at 334, and can localize this notification at 335. The guest API 110 can invoke and apply at least one business rule on the notification indicating delivery of request to the staff application 124 to process, at 316, this notification. The guest API 110 can send the processed notification to the guest application 120, which can output (for example, display) the processed notification indicating delivery of the request to the staff application 124.

Subsequent to the staff application 124 notifying the receipt of the request, the staff application 124 can receive an activity associated with the request from a staff member, such as an acceptance of the request, an initiation of addressing the request, a pausing of addressing the request, a completion of the request, a deletion of the request, editing the contents of the request, adding internal notes to the request, chatting with the guest, and/or applying any other workflow transitions, which may vary based on the request. The staff application 124 can send, at 338, a message indicating the activity associated with the request to the staff API 110. The staff API 110 can translate, at 340, the message indicating the activity associated with the request. The staff API 110 can localize, at 342, the message indicating the activity associated with the request. The staff API 110 can queue, at 344, the message indicating the activity associated with the request in the message queue 202.

The process can continue, as discussed above, to notify the guest application 124, via the guest API 108, regarding the activity associated with the request.

FIG. 3B is a flow diagram illustrating the process of communication, as enabled by the computational system 102, between a computing device 122 of the guest and a computing device 126 of the relevant department when the guest-related request is generated on behalf of the guest and on the staff application 124. The staff application 124 on the computing device 126 can send, at 346, a request requesting a service to the staff API 110. The staff API 110 can translate the request at 348. The translation can translate, in real-time, any language, currency, and time to a language and currency that may be preferred by the guest, and the local time of the property, respectively. The staff API 110 can localize the request at 350 in order to locally display the translated language, currency, and time. The staff API 110 can queue, at 352, the request in the message queue 202. Subsequent to 352, steps 310 to 344 can be executed in the order shown by FIG. 3A.

FIG. 3C is a flow diagram illustrating the process of communication, as enabled by the computational system 102, when an internal request is generated on the staff application 124. The staff application 124 on the computing device 126 can send, at 346, a request requesting a service to the staff API 110. Note that in this case, the request is an internal request, such as room cleaning or reporting a broken sink for a unit (for example, a room or a condominium) in the property. The staff API 110 can translate the request at 348. The translation can translate, in real-time, any language, currency, and time to a language and currency that may be preferred by the guest, and the local time of the property, respectively. The staff API 110 can localize the request at 350 in order to locally display the translated language, currency, and time. The staff API 110 can queue, at 352, the request in the message queue 202. Subsequent to 352, the steps shown in FIG. 3C can be executed in the order shown by FIGS. 3A and 3B.

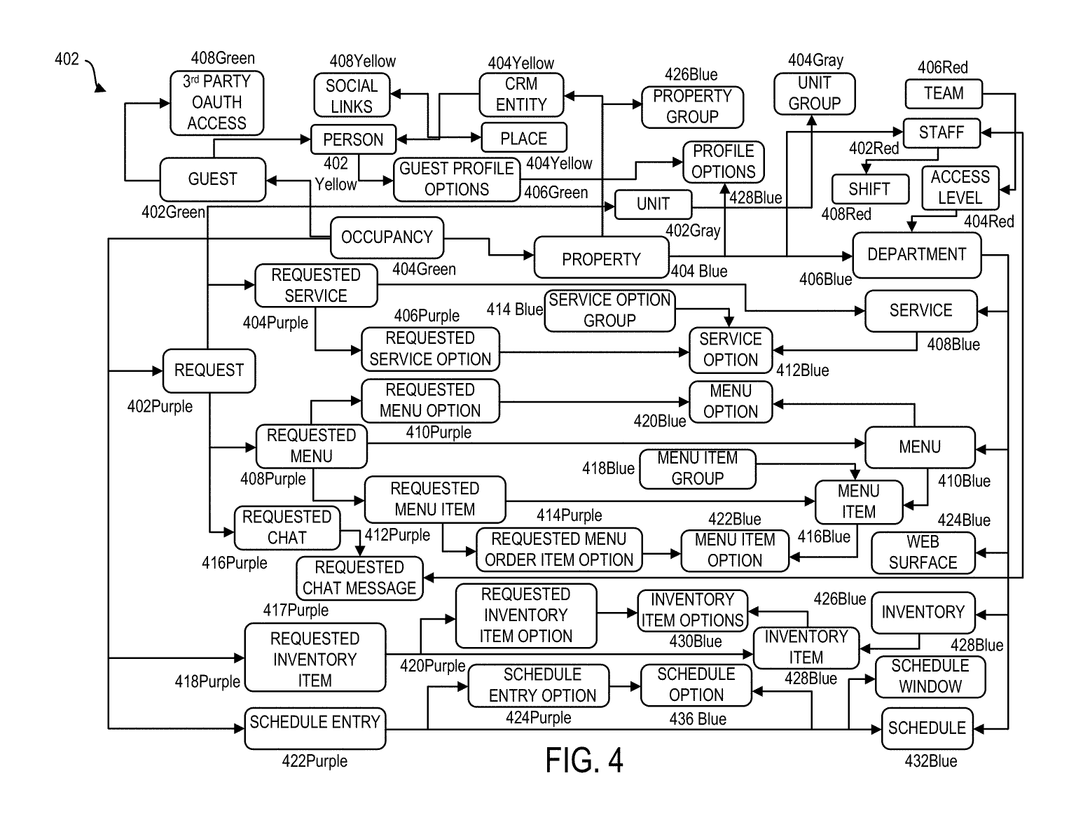

FIG. 4 illustrates a data-model 402 that shows an interlinkage between objects used within a programming code executed by the computational system 102, which enables communication between a computing device 122 of the guest application 120 and a computing device 126 of the staff application 124. These objects are at least some of the objects displayed by the guest application 120 and the staff application 124.

The data-model 402 can be split into various areas of domain context, such as property domain, unit domain, staff domain, customer relationship management (CRM) domain, guest domain, and guest request domain. The property domain objects have been shown in the diagram with reference phrase Blue at the end, the unit domain objects have been shown in the diagram with reference phrase Gray at the end, the staff domain objects have been shown in the diagram with reference phrase Red at the end, the CRM domain objects have been shown in the diagram with reference phrase Yellow at the end, the guest domain objects have been shown in the diagram with reference phrase Green at the end, and the guest domain objects have been shown in the diagram with reference phrase Purple at the end.

The property domain objects refer to the settings of the property that allow for digitally representing the full suite of available requests and information. Every property 404Blue can be composed of departments 406Blue. Each department 406Blue can offer an array of services 408Blue and menus 410Blue. Services 408Blue can allow for extra service options 412Blue to be specified, which can be visually grouped into a service options group 414Blue. Menus 410Blue can be composed of menu items 416Blue, which can also be grouped into a menu items group 418Blue and can offer various menu options 420B at checkout. Menu items 416Blue can also offer menu item options 422Blue. Each data object can include comprehensive metadata, such as name, label, etc. Web surfaces 424Blue are a way for properties 404Blue to offer extra data and third party controls integrated into the guest experience. The property can also specify additional information it requires from their guests to help provide better services. A property group 426Blue can include multiple properties 404Blue. A property 404Blue may belong to multiple property groups 424Blue. Profile options 428Blue can be associated with specific information that a property 404Blue would like to know about a guest of the property 404Blue. The profile options 428Blue are configurable by the property. A department 406Blue can also have various inventories 426Blue associated with it. Example of inventories 426Blue can be a parking lot and a package room. Each inventory 426Blue can specify inventory items 428Blue that the inventory 426Blue can contain. These inventory items 428Blue can have specific options (also referred to as properties) 430Blue. For example, a parking lot inventory can contain cars and bicycles as inventory items. Cars would provide a license plate while bicycles would not need to. A department 406Blue can have various schedules 432Blue. A schedule 432Blue can be defined by schedule windows 434Blue that specify availability or unavailability for a given date, day, or a range of dates or days. A schedule 432Blue can require specific options 436Blue to be specified when reserving a spot and making a guest schedule entry. For example, a schedule 432Blue can represent the availability of a conference room and require that when a conference room is scheduled, a schedule option 436Blue regarding setting up a television or a projector can be specified.

The unit domain objects are now described. Each property 404Blue can include units 402Gray that can be occupied. The unit 402Gray can offer various metadata and can be classified into unit types. The nature of unit occupation can be specific to the given industry. For example, the unit occupation can also be referred as a reservation when the property is a hotel, and can be referred as a lease when the property is a condominium. Every unit 402Gray can be geographically positioned in a group 404Gray, which can depend on various contexts relevant to the occupancy, such as floor, building, class, etc.

The staff domain objects are now described. The staff 402Red that works at a property 404Blue is represented here with all relevant information. The staff 402Red can be associated with access levels 404Red that offer the relevant permissions for accessing departments 406Blue and related requests. Staff 402Red can be a part of a team 406Red that offers central login capabilities for shared work stations. Staff 402Red can be associated with a shift 408Red that indicates when the staff 402Red is scheduled to work in a given week, month, or any other time period. The shifts 408Red can be used in various business rules for assigning work.

The customer relationship management (CRM) domain objects are now described. The CRM Infrastructure can store data about people 402Yellow and places 404Yellow. Each CRM entity 406Yellow can be connected to various social channels or links 408Yellow. The core entity 406Yellow can have some common properties, but the specific implementations of domains of person 402Yellow and place 404Yellow provide particular data points relevant to each domain. The content of the CRM entity 406Yellow can be specified by each property, as per their requirement and/or preference.

The guest domain objects are now described. The guest domain objects can include all the information about the guest 402Green that has occupancy 404Green on the given property. The guest domain can include general information about guest profile preferences or options 406Green, and can be enhanced by a relationship to the customer relationship management (CRM) Person 402Yellow, which can include personal information, such as preferences for floor, pillows, occupation, names of pets. All these preference are intended to know the guest better in a given context. The personal information can optionally be enhanced by customizable pieces of information captured in the guest profile. Any guest 402Green can be associated with various access tokens to third party systems 408Green. For example, a guest 402Green at a condominium (which is an example of a property 404Blue) can be associated with a preference of an on premise thermostat (for example, NEST thermostat by GOOGLE) that is reliant on an access based authorization token.

The guest request domain objects are now described. The request 402Purple can be placed by either the guest 402Green or staff 402Red. If a request 402Purple is placed by a guest 402Green, the request 402Purple can be associated with occupancy 404Green of the property 404Blue. If a request 402Purple is placed by staff, the request 402Purple can either be associated with a unit 402Gray or exist as an independent request. For a requested service 404Purple, the request 402Purple can provide information on details desired, state of the request, and other metadata fields. The details of the service 404Purple can be provided in the requested service options 406Purple where the guest side includes all the selected values for the given options. The requested menu 408Purple can be associated with requested menu options 410Purple and requested menu items 412Purple. Each requested menu item 412Purple can have one or more requested menu item options 414Purple. A request 402Purple can also be associated with chat functionality 416Purple that allows bi-directional communication from any language to any language. A request 402Purple can include a single or multiple set of services 404Purple, menus 408Purple, and chat messages 417Purple. The inventory 426Blue and schedule 432Blue can be associated with occupancy 404Green of the guest 402Green, but that may not be necessary. It may be possible for the inventory 426Blue and schedule 432Blue to be internal of associated guest 402Green. Registered inventory items 418Purple materialize specific instances of the item described in the facility domain. Specific details of that item 418Purple are described in the guest inventory item options 420Purple. For example, a parking garage (which is an example of inventory) managed by a valet department (which is an example of facility) can have an inventory of cars (which is an example of inventory item 418Purple), each having a corresponding license plate (which is an example of a registered inventory item option 420Purple). A schedule entry 422Purple can be a specific block applied to a schedule 432Blue, and can be either internal for a specific occupancy 404Green associated with a guest 402Green. The schedule entry 422Purple can provide details for the block via schedule entry options 424Purple.

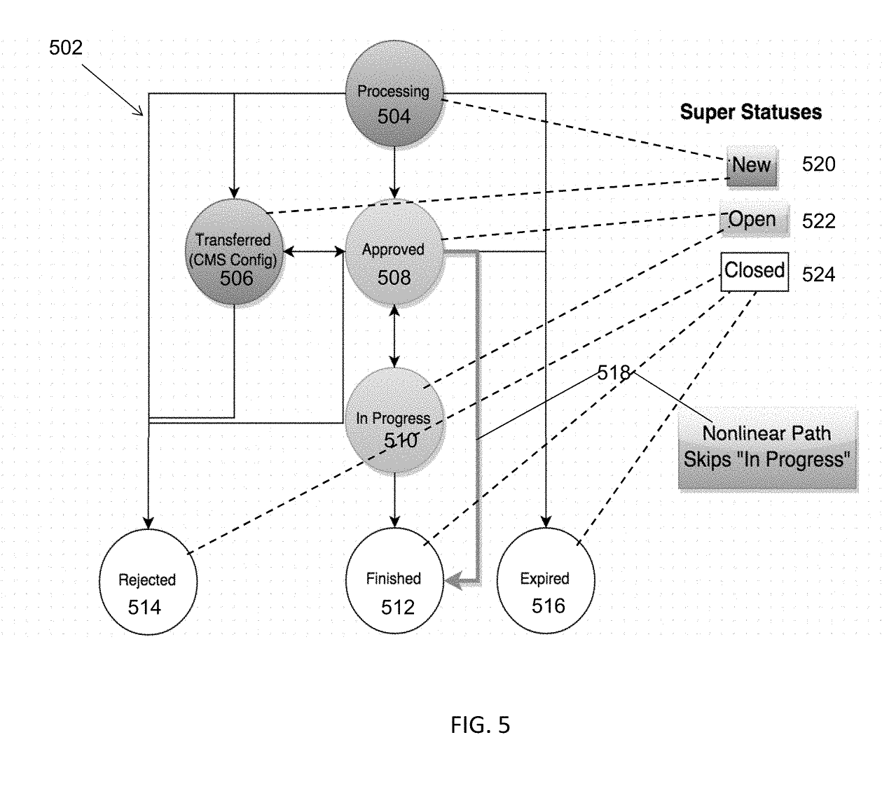

FIG. 5 illustrates a workflow model 502 that shows various states (also referred to as statuses) indicating actions that can be performed by a staff member while addressing a request. The various states, as interpreted by the computational system 102, can be processing 504, transferred 506, approved 508, in progress 510, finished 512, rejected 514, and expired 516. When a staff member performs an activity (that is, an action corresponding to a status), the staff member can use the staff application 124 to indicate the status.

In some implementations, the computational system 102 can enable the staff application 124 to accept statuses only in the order shown in the workflow model 502. For example, the staff application 124 can accept the status finished 510 only after the staff member had previously indicated the status in progress 510, as the status in progress 510 occurs immediately prior to the status finished 512. In other implementations (for example, for a staff application shown to a concierge at a property), the computational system 102 can enable the staff application 124 to accept statuses in any order. In such cases, the staff application 124 can, for example, accept the status finished 512 immediately after accepting the status approved 508, as shown by the connecting arrow 518.

The staff application 124 can allow some authorized staff members to alter the requirement whether the staff application 124 should accept statuses only in the order shown in the workflow model 502 based on a preference of the property management

Each of statuses processing 504, transferred 506, approved 508, in progress 510, finished 512, rejected 514, and expired 516 can be associated with a corresponding type, such as new 520, open 522, and closed 524. A conceptual mapping between statuses (processing 504, transferred 506, approved 508, in progress 510, finished 512, rejected 514, and expired 516) and their types (new 520, open 522, and closed 524) is shown using dotted lines in FIG. 5. These types can serve as logical groupings that allow for generation of explicit analytics and presentation of requests in the context of each department.

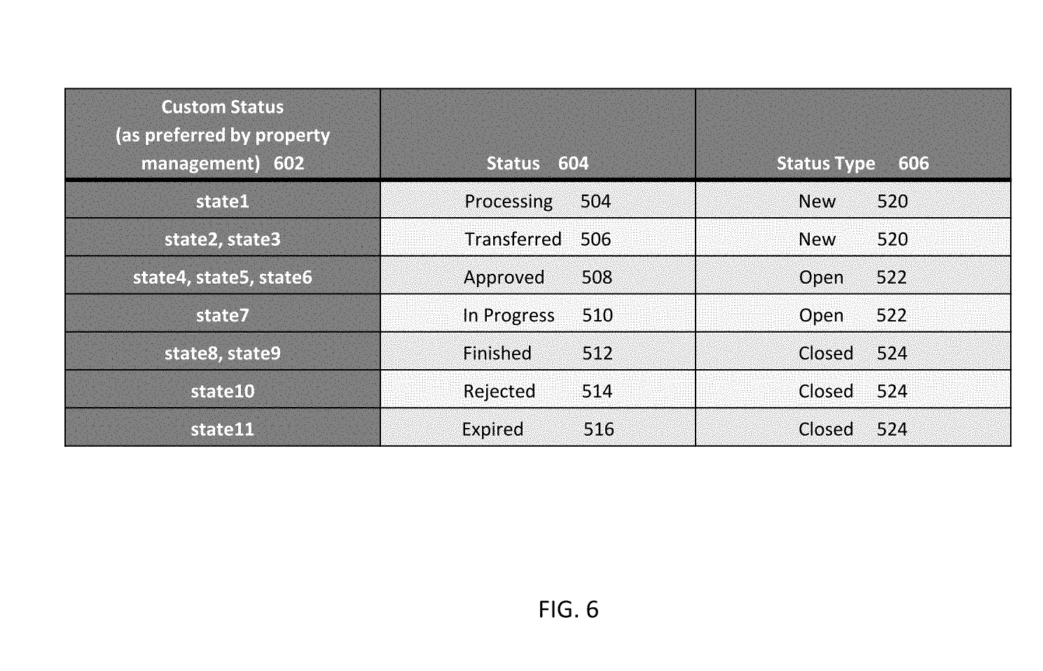

FIG. 6 illustrates a tabular mapping between a custom status 602 customized for property management, status 604 interpreted by the computational system 102, and a type 606 of the status. Note that the statuses 604 have been mapped with status types 604 in accordance with the associations shown by dotted lines in FIG. 5. The need for custom statuses 602 is described below.

While the computational system 102 interprets states representing actions performed by a staff member as processing 504, transferred 506, approved 508, in progress 510, finished 512, rejected 514, and expired 516, property management may instead prefer to see statuses as state1, state2, state3, state4, state5, state6, state7, state8, state9, state10, and state11. To provide the preferred statuses in the staff application 124 provided to staff members of the property with this preference, the computational system 102 can be configured to map the statuses 604 interpreted by the computational system 102 with custom statuses 602 preferred by the property management. In one example, the custom statuses can have a 1-1 or an N-1 relationship back to the original statuses. That is, there can be one or more custom statuses that map to a single original status. This mapping is illustrated in the table shown in FIG. 6. Thus, the computational system 102 can be used to advantageously customize the staff application 124 for each property as per the specifications and preferences of associated property management.

The staff application 124 can allow some authorized staff members to add a new custom status 602, delete an existing custom status 602, and/or alter mappings between the custom statuses 602 and statuses 604 interpreted by the computational system 102. The staff application 124 can also allow authorized staff members to create, edit, and/or delete the rules that govern which statuses can be moved into (that is, associated with) another status. These rules can be referred to as transitions. Each transition can describe an associated starting and ending status. Each transition can have a user-specified name to describe the transition.

A workflow can apply to all requests in the context of a property, a specific facility, or a service/menu in that facility. A workflow can be owned by the system, a property group, or a property. If owned by the system, any property can use the workflow but cannot change it. If owned by the property group, any property belonging to the property group can use the workflow but can not change it. Specific property workflows can be owned and managed by the property.

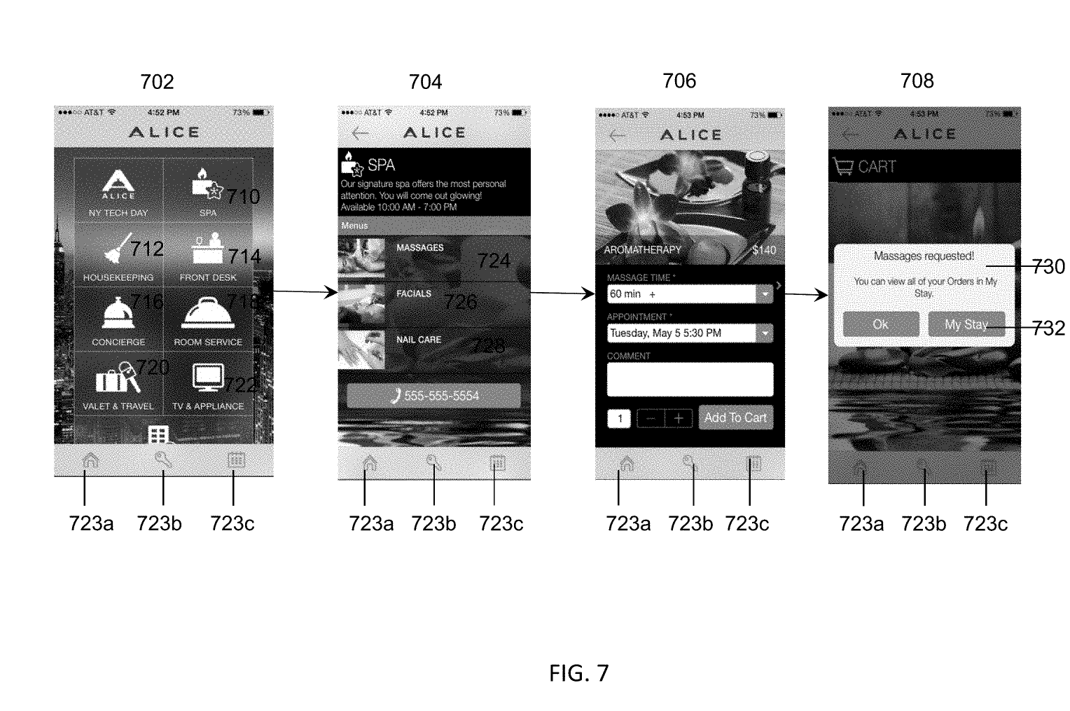

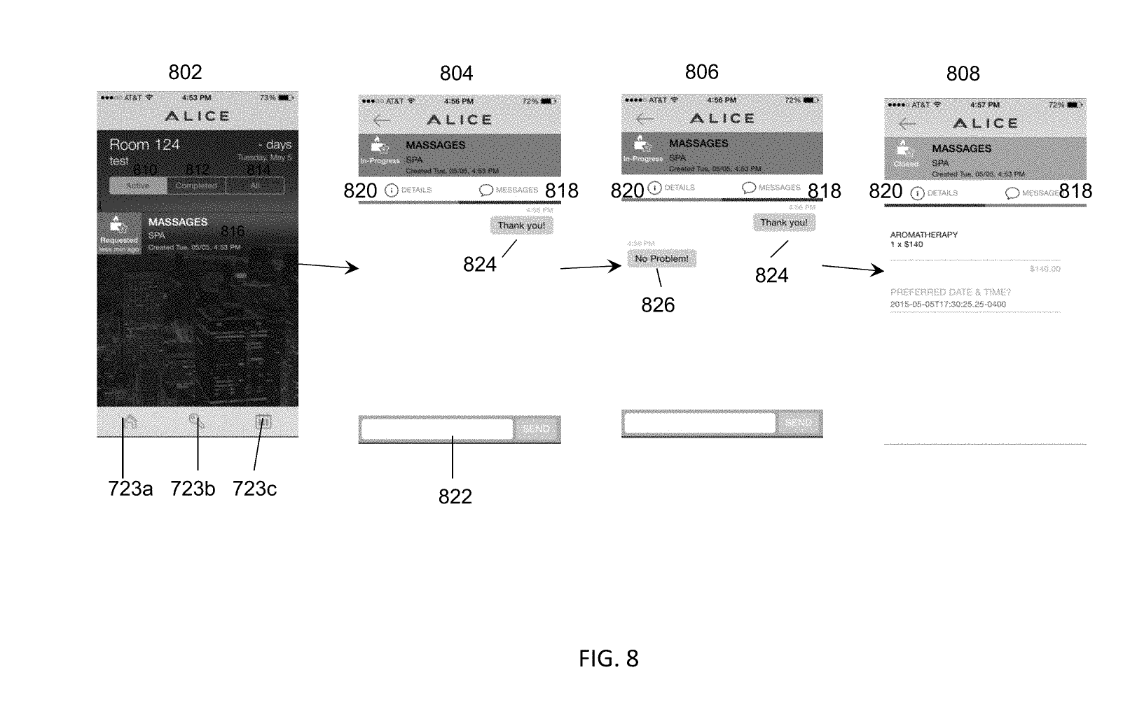

FIG. 7 illustrates screens 702, 704, 706, and 708 executed in series by the guest application 120 to enable a guest to request a service. The guest application 120 displaying the screens 702, 704, 706, and 708 is executed on a computing device 122, which is a smartphone in the example shown. The screen 702 displays various departments that offer services available to a guest. Some examples of such departments are spa department 710, housekeeping department 712, front desk department 714, concierge department 716, room service department 718, valet and travel department 720, and television and appliance department 722. The departments shown can be customized for each property. The screen 702 can further includes a home link 723a, an authentication link 723b, and an orders link 723c. The guest application 120 can display the home screen 702 whenever the home link 723a is selected. The guest application 120 can display, whenever the authentication link 723b is selected, an authentication page that allows a guest to log out of the guest application 120. The guest application 120 may subsequently allow the guest to log back in. The guest application 120 can display, whenever the orders link 723c is selected, a screen (for example, screen 802, as shown by FIG. 8, which is discussed below) displaying orders or requests placed by the guest during his or her current stay.

When a guest selects a particular department on screen 702, the guest application 120 can display a screen showing services provided by the selected department. For example, when a guest selects the spa department 710 on the screen 702, the guest application 120 can display the screen 704, which displays services provided by the spa department 710. These services can include massages 724, facials 726, and nail care 728.

When the guest selects a particular service on the screen 704, the guest application 120 can display another screen showing details associated with the selected service. For example, when the guest selects massages 724 on the screen 704, the guest application 120 can display the screen 706 that can allow the guest to schedule the massage.

The screen 706 can allow the guest to schedule the massage and add the payment for this service to their bill for the property. Once the guest schedules the massage service, the guest application 120 can display the screen 708, which can display a notification 730 that the massage service has been requested. The notification 730 can further include an orders link 732, which, when selected by the guest, can make the guest application 120 display all the orders placed by the guest during his or her current stay.

FIG. 8 illustrates screens 802, 804, 806, and 808 executed in series by the guest application 120 to display a request placed on a computing device 122 of a guest of a property and to enable communication related to the request between a computing device 122 of the guest and a computing device 126 of a staff member of the property. The guest application 120 displaying the screens 802, 804, 806, and 808 is executed on a computing device 122, which is a smartphone in the example shown. The screen 802 can display requests for service placed by the guest. The screen 802 can be displayed when the guest selects the orders link 723a or the orders link 732. The screen 802 can further present an active orders link 810, a completed orders link 812, and an all orders link 814, which, when selected by a guest, make the screen 802 display active orders 816, completed orders, and all orders, respectively.

When the guest selects an active order (that is, a requested service that has not been completed), the guest application 120 can display the screen 804. The screen 804 can include a messages link 818, which, when selected by the guest, can make the guest application 120 display messages exchanged between the guest and staff member(s) of the property. The screen 804 can further include a details link 820, which, when selected by the guest, can make the guest application 120 display details associated with the requested service, as shown by screen 808. The screen 804 can further include a chat bar 822, where a guest can input text and/or graphical details to chat with the staff member. When the guest inputs a text 824, the guest application 120 can display the text 824 on the screen 804.

The screen 806 can display the chat area where a staff member of the property receives an optional response 826 in reply to the text 824. This way, the guest can chat with the staff member addressing the request.

The guest application 120 can display the screen 808 when the user selects the details link 820. The screen 808 can display details associated with the requested service.

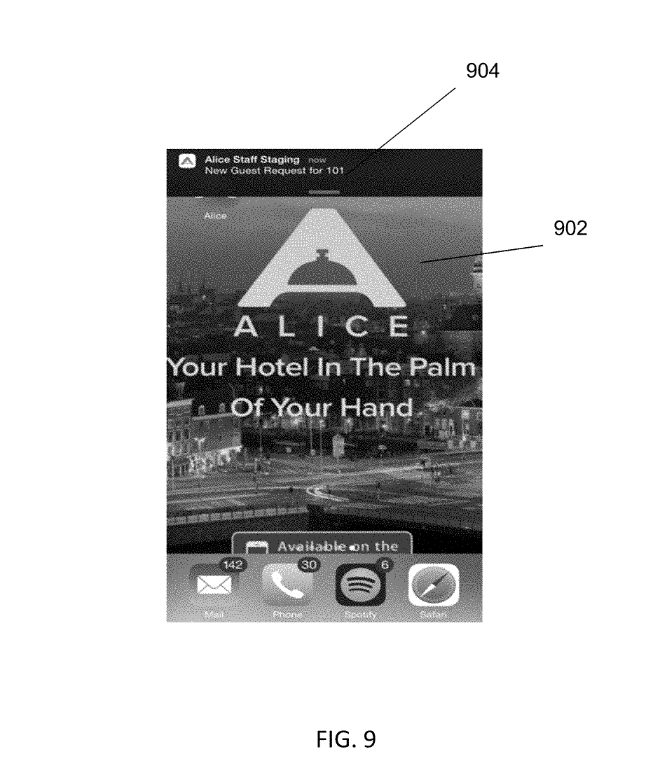

FIG. 9 illustrates a graphical user interface 902, of a computing device 126 (that is, smartphone, in this example) that executes a staff application 124, displaying a notification 904 indicating that the staff application 124 has received a new request. The staff application 124 can display the notification 904 immediately after a computing device 122 of a guest places the request.

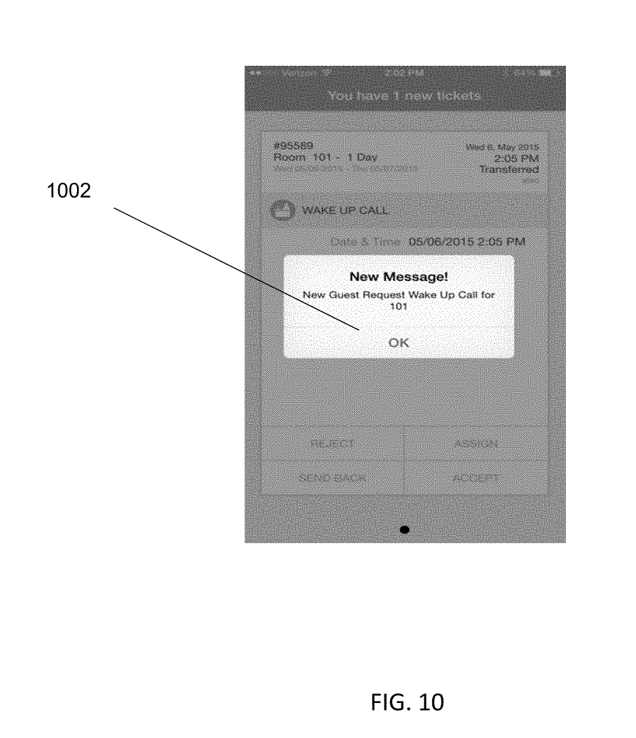

FIG. 10 illustrates a notification 1002, indicating receipt of a new request from a computing device 122 of a guest, within a staff application 124 when a staff member is using the staff application 124.

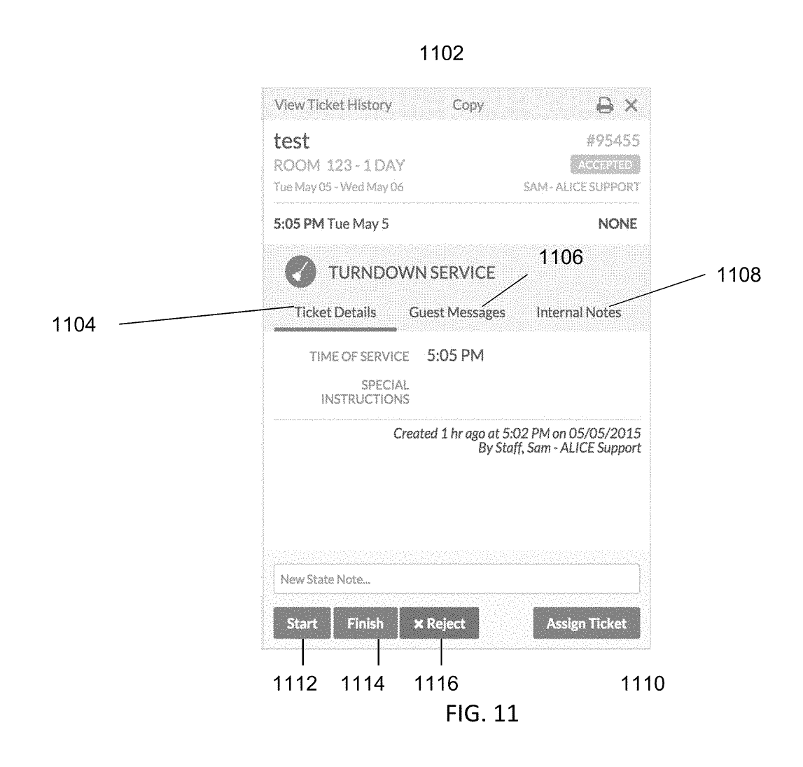

FIG. 11 illustrates a screen 1102 executed by the staff application 124 to display a ticket generated for a request placed on a computing device 122 of a guest. The screen 1102 can include a ticket details link 1104, a guest messages link 1106, and an internal notes link 1108. When the staff member selects the ticket details link 1104, the screen 1102 can display details of the ticket associated with the request by a guest. When the staff member selects the guest messages link 1106, the screen 1102 can display messages exchanged between the staff member and the guest. When the staff member selects the internal notes link 1104, the screen 1102 can display internal notes generated by the staff member that are not displayed to the guest.

The screen 1102 can further include various links, such as an assign ticket link 1110, a start link 1112, a finish link 1114 and a reject link 1116. Each of the links 1110, 1112, 1114, and 1116 can represents a transition from one workflow status to another. Customized workflows can alter these links based on the property's desired workflow customization. The staff member can select the assign ticket link 1110 when the staff member desires to assign the requested service to another, more relevant, staff member. The staff member can select the start link 1112 when the staff member starts addressing the request by the guest. The staff member can select the finish link 1114 when the staff member finishes addressing the request by the guest. The staff member can select the reject link 1116 when the staff member rejects the request by the guest. The start, finish, and reject described here correspond to actions performed by a staff member. When the staff application 124 receives selection of one of one or more of the start link 1112, the finish link 1114 and the reject link 1116 (for example, the selection of finish link 1114 indicating that the requested service has been completed), the computational system 102 can send a notification to the guest application 120, which can then display that notification to the guest, as described above in more detail by FIGS. 2 and 3.

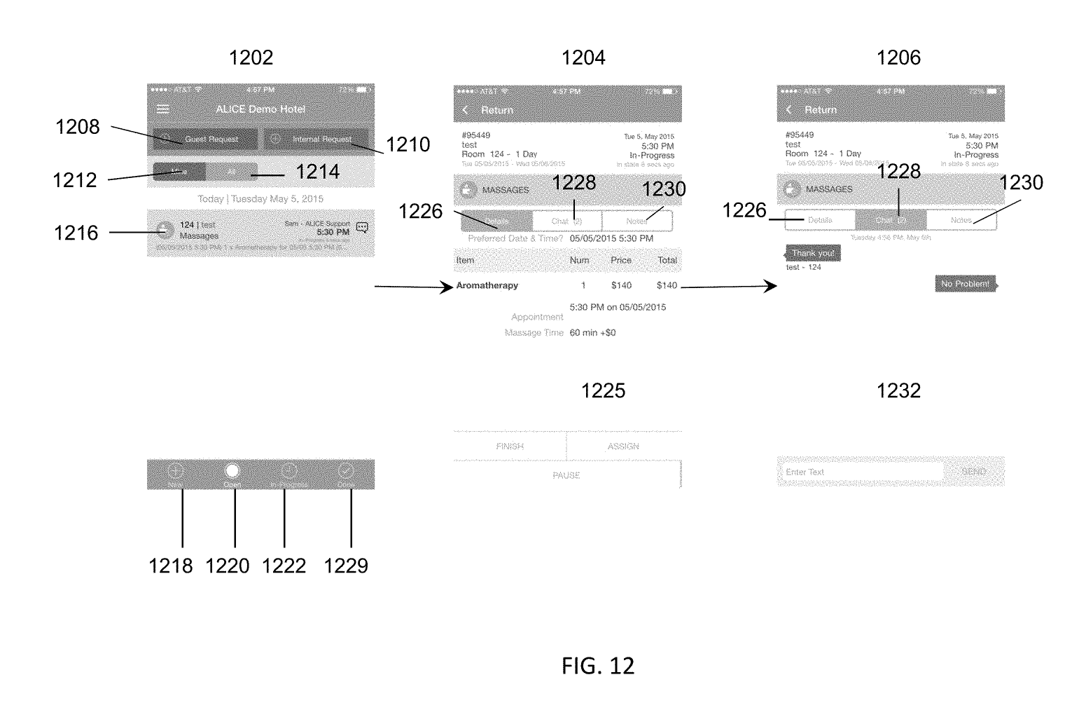

FIG. 12 illustrates screens 1202, 1204, and 1206 executed in series by the staff application 124 to display a request placed on a computing device 122 of a guest, details associated with the request, and communication regarding the request between a computing device 122 of a staff member and a computing device 124 of the guest. The staff application 124 displaying the screens 1202, 1204, and 1206 is executed on a computing device 126, which is a smartphone in the example shown. The screen 1202 can display a guest requests link 1208 and an internal requests link 1210. When a staff member selects the guest requests link 1208, the staff application 124 can create a new guest-based request on behalf of a guest. When a staff member selects the internal requests link 1210, the staff application 124 can create a new internal request. The screen 1202 can display all existing requests, including the guest-based requests and the internal requests.

The screen 1202 can further display a mine requests link 1212 and an all requests link 1214. When a staff member selects the mine requests link 1212, the screen 1202 can display the requests that are assigned to the staff member logged into the staff application 124. When a staff member selects the all requests link 1214, the screen 1202 can display the requests, including those assigned to all the staff members of the property and those that have not yet been assigned to anyone.

The screen 1202 can also display the following links: new link 1218, open link 1220, in progress link 1222, and a done link 1224. The new link 1218, open link 1220, in progress link 1222, and a done link 1224 are three main groupings that can be used to describe any created custom statuses. “New” reflects requests that have not yet been acknowledged by a staff member. “Open” is for requests that have been acknowledged but are not finished (examples include “Accepted”). “In Progress” shows requests that a staff member has begun working on but is not finished (examples include

“In Progress”). “Done” reflects requests that staff members have completed. Clicking on each link will filter the list of displayed requests to show only those requests that have a workflow or custom workflow state which maps to those status groupings.

When the staff member selects a request 1216, the staff application 124 can display the screen 1204 that can show details 1225 associated with the selected request 1216. The screen 1204 can include a details link 1226, a chat link 1228, and an internal notes link 1230. When the staff member selects the details link 1226, the staff application 124 can display the details 1225 associated with the selected request 1216. When the staff member selects the chat link 1228, the staff application 124 can display the chat 1232 (as shown by screen 1206) between the staff member addressing the request and the guest. When the staff member selects the internal notes link 1230, the staff application 124 can display internal notes that can be shared amongst staff members but are neither conveyed to nor displayed by the guest application 120.

The screen 1206 can display chat 1232 between the staff member who is addressing the request and the guest. The staff application 124 can display the chat 1232 when the staff member selects the chat link 1228.

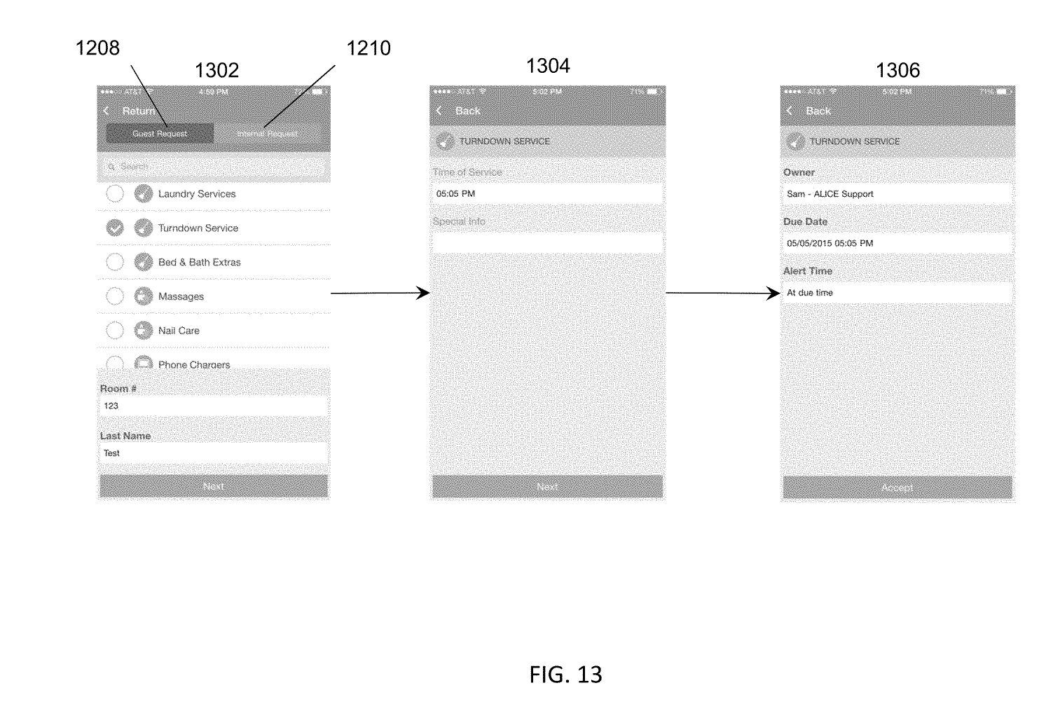

FIG. 13 illustrates screens 1302, 1304, and 1306 executed in series by the staff application 124 to enable a staff member to generate an internal request or a guest request on behalf of a guest. The staff application 124 displaying the screens 1302, 1304, and 1306 is executed on a computing device 126, which is a smartphone in the example shown.

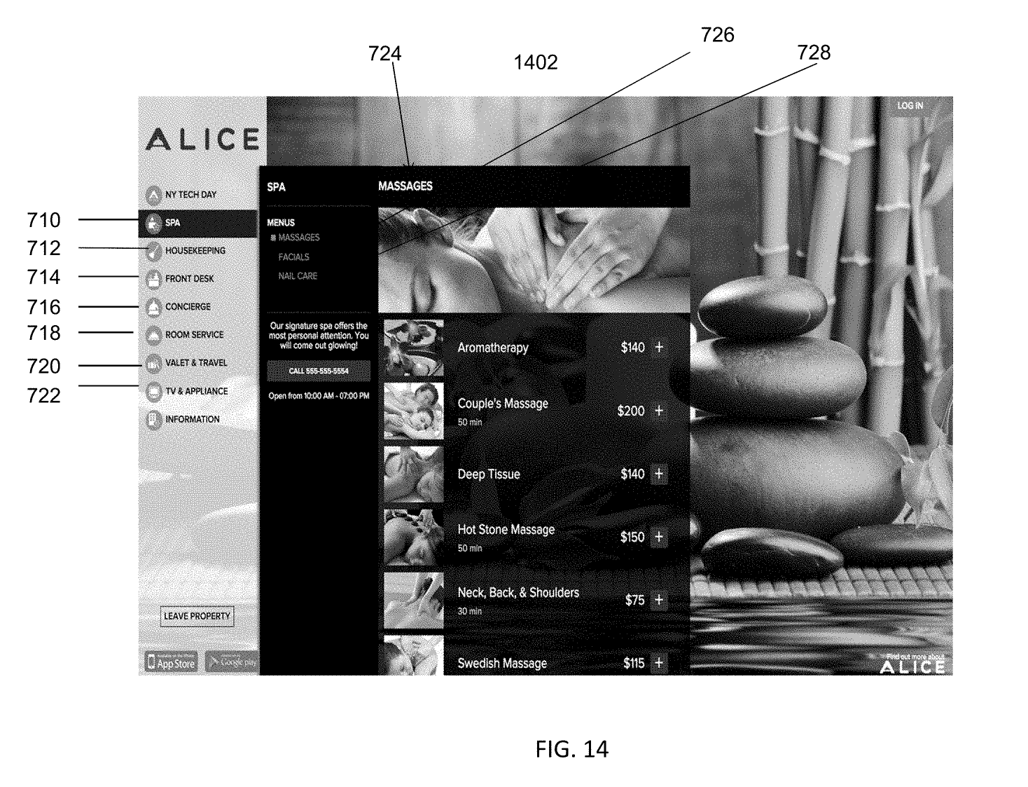

FIG. 14 illustrates a web-page 1402 executed by the guest application 120, when accessed by a guest via a web browser, to enable the guest to generate a request. The web-page 1402 can display: various departments (for example, spa department 710, housekeeping department 712, front desk department 714, concierge department 716, room service department 718, valet and travel department 720, and television and appliance department 722) that offer services available to a guest, services (for example, massages 724, facials 726, and nail care 728) provided by a selected department (for example, the spa department 710), and details (for example, prices and options to schedule a massage) associated with a selected service (for example, massages 724).

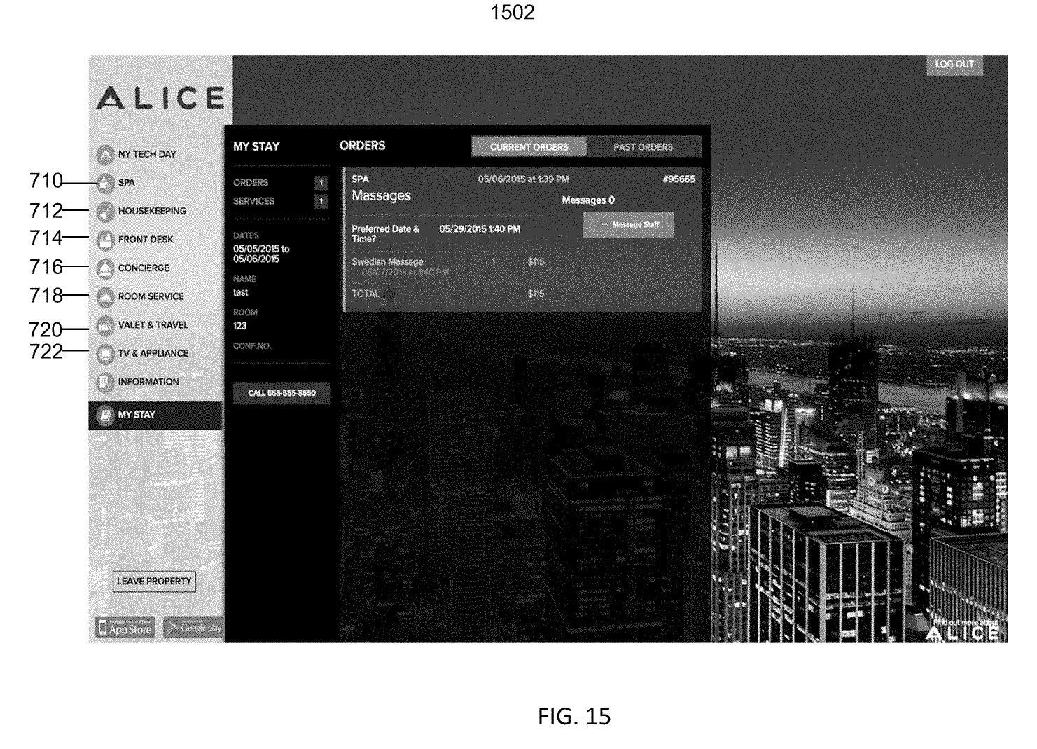

FIG. 15 illustrates a web-page 1502 executed by the guest application 120, when accessed on a computing device 122 of a guest via a web browser, to display the current orders (that is, current requests) and past orders (that is, past requests) placed by the guest.

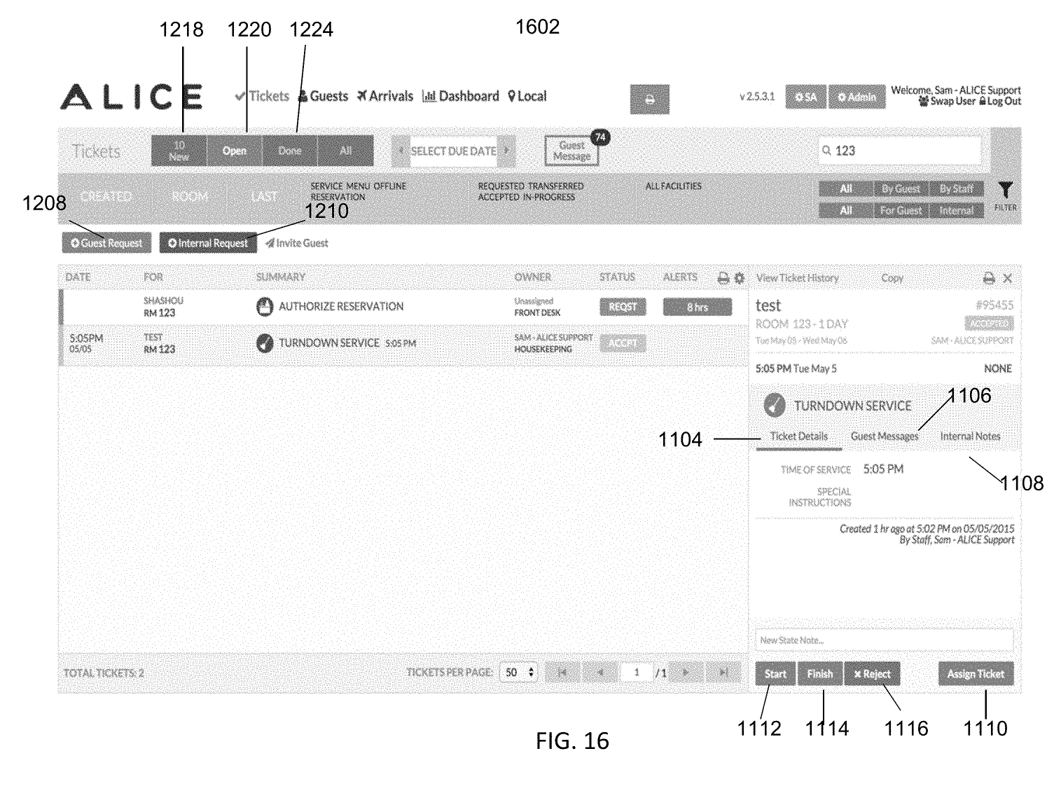

FIG. 16 illustrates an example of a web-page 1602 executed by the staff application 124, when accessed by a staff member via a web browser, to display guest requests, internal requests, and a ticket and current custom handling status for each request.

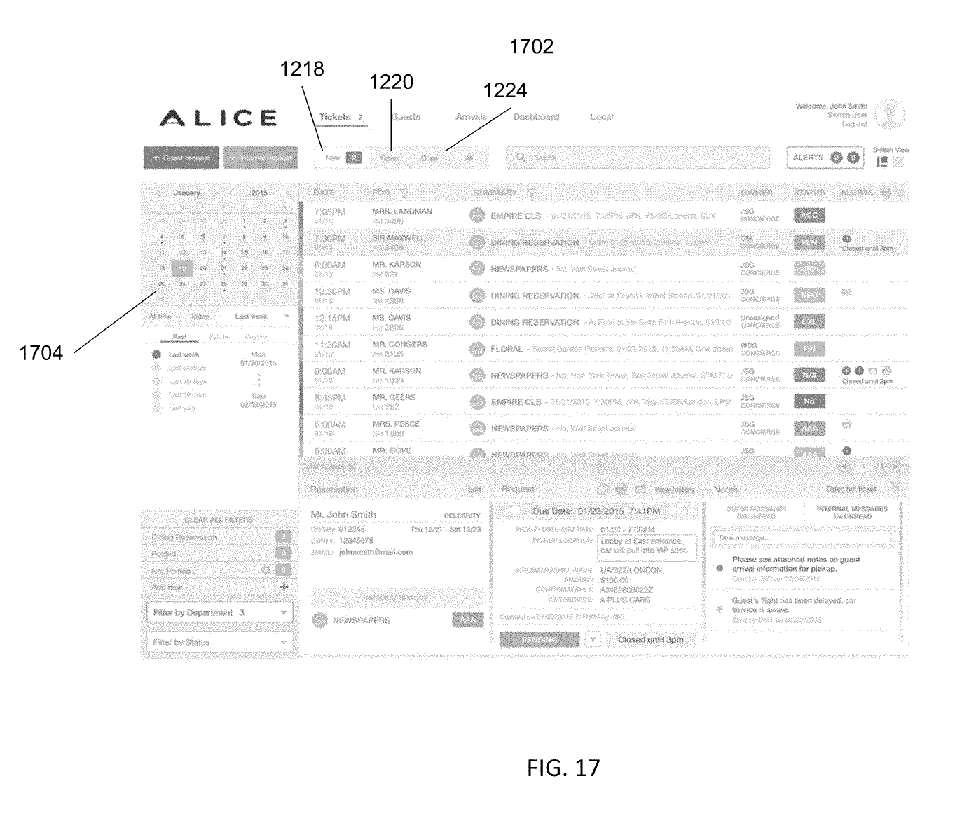

FIG. 17 illustrates another example of a web-page 1702 executed by the staff application 124, when accessed by a staff member via a web browser, to display guest requests, internal requests, and a calendaring tool 1704 that allows filtering data based on specific dates and/or times. The web-page 1702 includes a tool 1706 that allows a staff member to create persistent customized filters that can be activated to perform a set of logic operations used to filter the list of requests viewed.

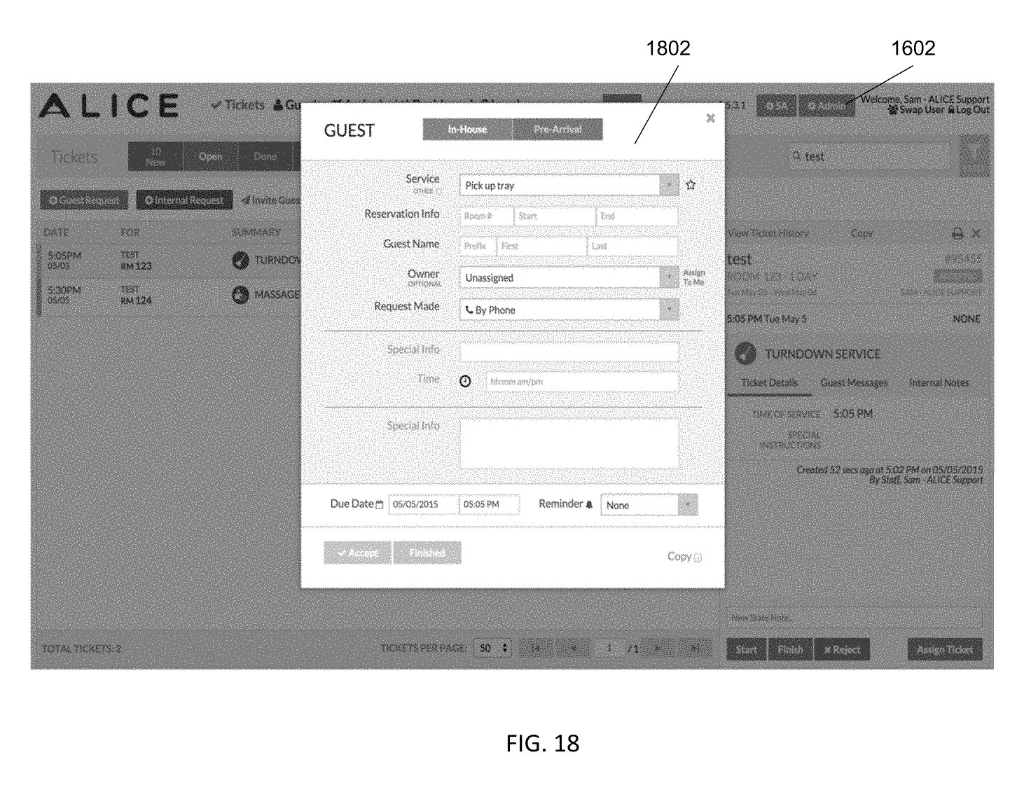

FIG. 18 illustrates a pop-up screen 1802 popping out of a web-page 1602 executed by the staff application 124, when accessed by a staff member via a web browser, to generate/create requests related to at least one of guest rooms and guests.

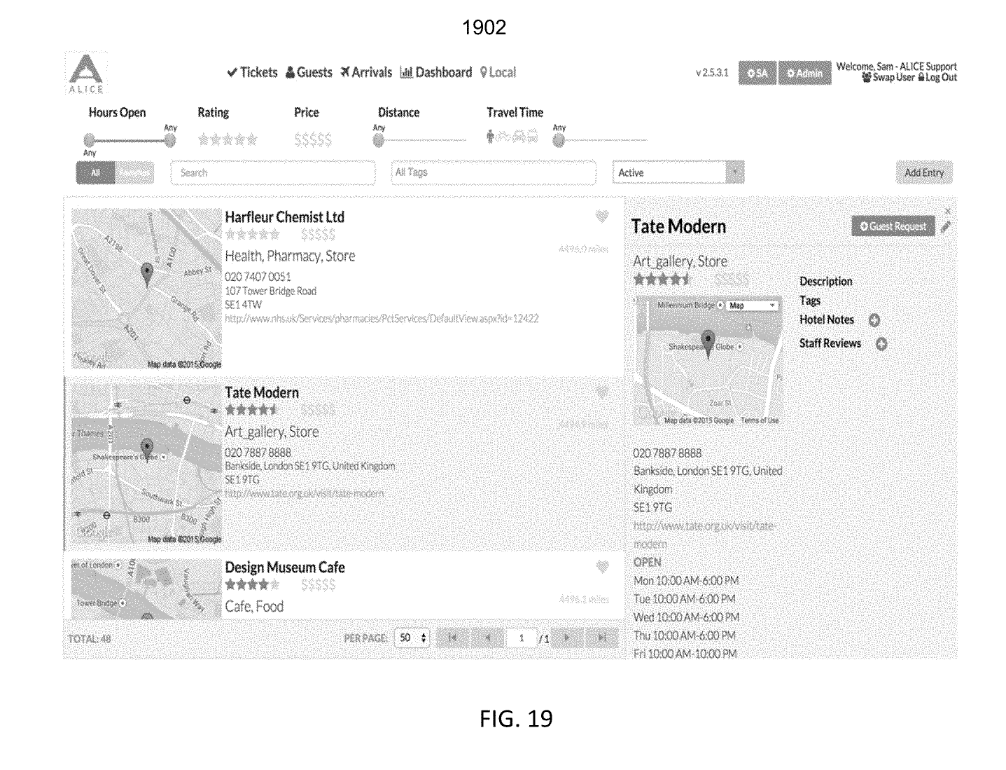

FIG. 19 illustrates a web-page 1902 executed by the staff application 124, when accessed by a concierge staff member via a web browser, to enable the concierge staff member to make recommendations while using the staff application 124. The web-page 1902 also enables a concierge staff members to add additional locations with location-specific data (for example, address, phone, hours of operation, internal staff comments, ratings, and so on) in order to increase their list of recommendable people, places, and things.

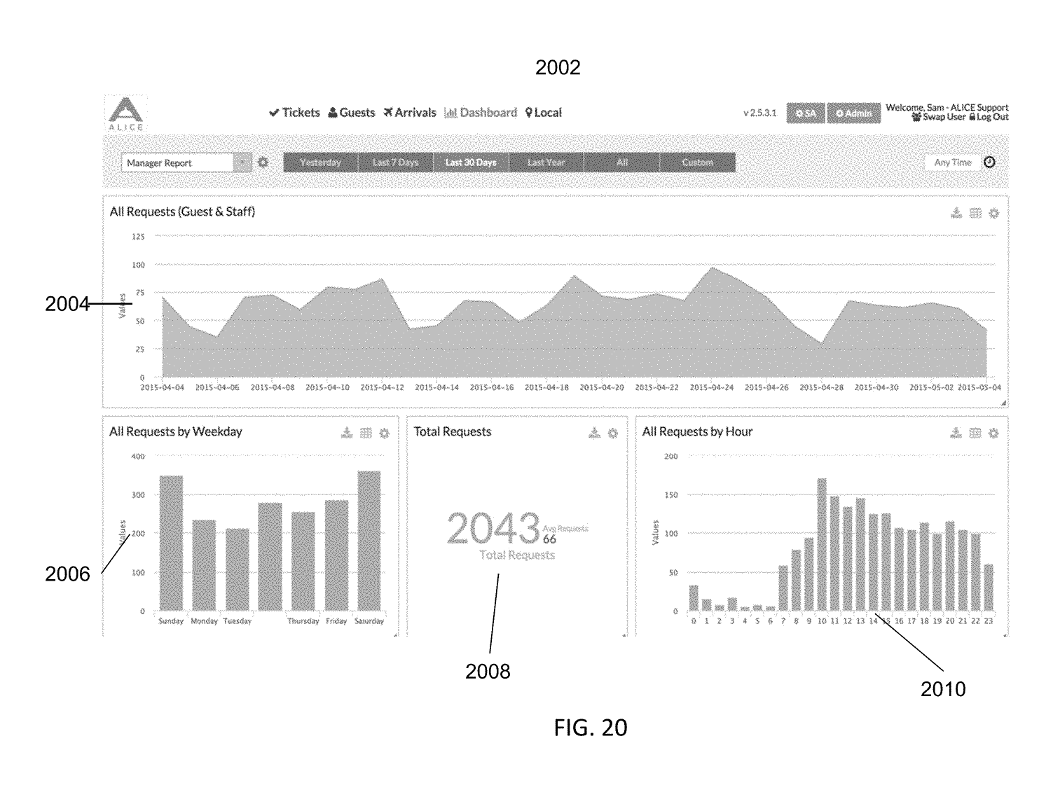

FIG. 20 illustrates a web-page 2002 executed by the staff application 124, when accessed by an authorized staff member (for example, a property administrator or manager) via a web browser, to display analytics 2004, 2006, 2008, and 2010 to the authorized staff member. The staff application 124 can execute a data query widget, an analytics generation widget, and a data display widget. Each widget is a self-contained piece of programming code. The data query widget can run a database query programming code (for example, a SQL programming code) to query the data warehouse 206. The analytics generation widget can generate analytics 2004, 2006, 2008, and 2010 by using the data received in response to the query. The data display widget can display the analytics 2004, 2006, 2008, and 2010. These widgets can perform their functions in real time so that the displayed analytics 2004, 2006, 2008, and 2010 indicate the latest possible information.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can be have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other embodiments may be within the scope of the following claims.

1.-33. (canceled)

34. A computational system comprising:
a staff application programming interface operable to receive a request, in a first language, generated by a first staff computing device associated with staff of a property and operably coupled to the staff application programming interface via a first communication network; and
one or more computing units operable to receive the request from the staff application programming interface, the one or more computing units operable to translate the request from the first language into a second, different language to form a translated request;
wherein the staff application programming interface is further operable to receive the translated request in the second, different language and to send the translated request in the second, different language to a second staff computing device associated with staff of the property and operably coupled to the staff application programming interface via a second communication network.

35. The computational system of claim 34, further comprising:
computer memory storing data for translating text in the first language to text in the second, different language; and
wherein the one or more computing units is operably coupled to the computer memory and is operable to translate the request from the first language into the second, different language to form the translated request based at least in part on the data for translating text stored by the computer memory.

36. The computational system of claim 34, wherein:
the one or more computing units is operably coupled to a translation application programming interface and is operable to translate the request from the first language into a second, different language to form the translated request based at least in part on the one or more computing units sending text in the first language to the translation application programming interface and receiving corresponding translated text from the translation application programming interface in the second, different language.

37. The computational system of claim 34, further comprising:
computer memory storing data for translating text in the first language to text in the second, different language; and
wherein the one or more computing units is operably coupled to the computer memory and is operable to:
translate the request from the first language into the second, different language to form the translated request based at least in part on the data for translating text stored by the computer memory; and
when the data stored by the computer memory is insufficient to complete translation of the request from the first language into the second, different language, send text in the first language to a translation application programming interface operably coupled to the one or more computing units and receive corresponding translated text from the translation application programming interface in the second, different language.

38. The computational system of claim 34, wherein:
the staff application programming interface is further operable to receive a response to the request, in the second, different language, generated by the second staff computing device;
the one or more computing units is operable to receive the response from the staff application programming interface and to translate the response from the second, different language into the first language to form a translated response; and
the staff application programming interface is further operable to send the translated response in the first language to the first staff computing device.

39. The computational system of claim 34 wherein:
the staff application programming interface is operable to receive the request generated by a staff application running on the first staff computing device, which is a mobile device associated with a staff member of the property; and
the staff application programming interface is operable to send the translated request to a staff application running on the second staff computing device, which is a mobile device associated with a second staff member of the property.

40. The computational system of claim 34, wherein:
the first communication network is one of internet and intranet; and
the second communication network is one of the internet and the intranet.

41. A computer-implemented method comprising:
receiving, by a staff application programming interface, a request in a first language generated by a first staff computing device associated with staff of a property and operably coupled to the staff application programming interface via a first communication network;
receiving, by one or more computing units, the request from the staff application programming interface;
translating, by the one or more computing units, the request from the first language into a second, different language to form a translated request;
receiving, by the staff application programming interface, the translated request in the second, different language; and
sending, by the staff application programming interface, the translated request in the second, different language to a second staff computing device associated with staff of the property and operably coupled to the staff application programming interface via a second communication network.

42. The computer-implemented method of claim 41, further comprising:
storing, in computer memory, data for translating text in the first language to text in the second, different language; and
wherein said translating comprises translating, by the one or more computing units, the request from the first language into the second, different language to form the translated request based at least in part on the data for translating text stored by the computer memory.

43. The computer-implemented method of claim 41, wherein:
said translating comprises translating, by the one or more computing units, the request from the first language into a second, different language to form the translated request based at least in part on the one or more computing units sending text in the first language to a translation application programming interface and receiving corresponding translated text from the translation application programming interface in the second, different language.

44. The computer-implemented method of claim 41, further comprising:
storing, in computer memory, data for translating text in the first language to text in the second, different language; and
said translating, by the one or more computing units, comprises:
translating, by the one or more computing units, the request from the first language into the second different language to form the translated request based at least in part on the data for translating text stored by the computer memory; and
when the data stored by the computer memory is insufficient to complete translation of the request from the first language into the second different language, sending, by the one or more computing units, text in the first language to a translation application programming interface operably coupled to the one or more computing units and receiving corresponding translated text from the translation application programming interface in the second different language.

45. The computer-implemented method of claim 41, further comprising:
receiving, by the staff application programming interface, a response to the request in the second, different language, generated by the second staff computing device;
receiving, by the one or more computing units, the response from the staff application programming interface;
translating, by the one or more computing units, the response from the second, different language into the first language to form a translated response; and
sending, by the staff application programming interface, the translated response in the first language to the first staff computing device.

46. The computer-implemented method of claim 41 wherein:
said receiving by the staff application programming interface comprises receiving the request generated by a staff application running on the first staff computing device, which is a mobile device associated with a staff member of the property; and
said sending by the staff application programming interface comprises sending the translated request to a staff application running on the second staff computing device, which is a mobile device associated with a second staff member of the property.

47. The computer-implemented method of claim 41 wherein:
said receiving the request by the staff application programming interface via the first communication network comprises receiving the request via the internet or intranet; and
said sending the translated request by the staff application programming interface via the second communication network comprises sending the translated request via the internet or intranet.
